(19) United States
(12) Patent Application Publication
(10) Pub. No.: US 2015/0135240 A1
(43) Pub. Date: May 14, 2015

(54) VIDEO DISPLAY TERMINAL, VIDEO TRANSMISSION TERMINAL, VIDEO COMMUNICATION SYSTEM, VIDEO DISPLAY METHOD, VIDEO TRANSMISSION METHOD, AND COMPUTER-READABLE RECORDING MEDIUM RECORDING PROGRAM

(71) Applicant: OLYMPUS CORPORATION, Tokyo (JP)

(72) Inventor: Kazuyuki Shibuya, Sagamihara-shi (JP)

(73) Assignee: OLYMPUS CORPORATION, Tokyo (JP)

(21) Appl. No.: 14/498,634

(22) Filed: Sep. 26, 2014

(30) Foreign Application Priority Data
Nov. 13, 2013 (JP) 2013-235040

(51) Int. Cl. H04N 21/4363; H04N 21/222; H04N 7/10

(52) U.S. Cl. CPC H04N 21/43637; H04N 7/106; H04N 21/2223
USPC 725/81

(57) ABSTRACT

A video display terminal includes a wireless communication interface, a display interface, an operation interface, and a control unit. The control unit causes the wireless communication interface to wirelessly transmit a video transmission request to a video transmission terminal joining a wireless network constructed by the own video display terminal if the operation interface receives a video display instruction when the own video display terminal operates as an access point constructing the wireless network, causes the display interface to display a video for the own video display terminal wirelessly transmitted from the video transmission terminal in response to the video transmission request and wirelessly received by the wireless communication interface, and causes the wireless communication interface to wirelessly transmit the video for the own video display terminal to another video display terminal joining the wireless network constructed by the own video display terminal.

### BACKGROUND OF THE INVENTION

1. Field of the Invention

The present invention relates to a video display terminal, a video transmission terminal, a video communication system, a video display method, a video transmission method, and a computer-readable recording medium recording a program for performing video communication via a wireless network. Priority is claimed on Japanese Patent Application No. 2013-235040, filed Nov. 13, 2013, the content of which is incorporated herein by reference.

2. Description of Related Art

According to the speedup of a wireless local area network (LAN), the spread of quality of service (QoS), or the like, the number of opportunities to communicate a video between devices using the wireless LAN is increasing. Users demand high resolution and low compression (or non-compression) of a video and high quality of video communication in which a delay between a video source terminal and a video reproduction terminal is reduced. Thus, a data amount of video communication occupied by communication within a network by the wireless LAN increases and preferential communication of the video communication tends to be required.

When a terminal performs video communication in the wireless LAN network (infrastructure network) in which a general access point (hereinafter abbreviated as AP) is provided, communication via the AP occurs. Alternatively, communication of a terminal other than the terminal which performs the video communication occurs within the same wireless LAN network. Thereby, a decrease in a communicable data amount and an increase in a data delay amount occur. On the other hand, users need high quality in video communication.

To address this problem, a soft AP for implementing an AP function in software has recently tended to be embedded in a terminal such as a personal computer (PC), a television (TV), or a mobile phone. A network in which one terminal of a video source terminal and a video reproduction terminal serves as a soft AP is generated and the other terminal is connected to the terminal operating as the soft AP, so that direct video communication can be performed between the video source terminal and the video reproduction terminal. Thereby, a large amount of data can be communicated with a low delay and the practicability of high quality video communication can be increased.

The following form is used for connection between terminals when direct video communication is performed using the soft AP. A wireless terminal serves as an AP or a station (hereinafter abbreviated as STA). In addition, the wireless terminal serves as a video display terminal configured to display a video or a video transmission terminal configured to transmit the video to the video display terminal in a video session. Two relationships as illustrated in FIGS. 20 and 21 can be present in a relationship between the role of the wireless terminal and the roles in the video session.

FIG. 20 illustrates a state in which a video transmission terminal (AP) 301 and a video display terminal (STA) 302 perform direct video communication. The video display terminal (STA) 302 is connected to a wireless network 300 constructed by the video transmission terminal (AP) 301, and the video transmission terminal (AP) 301 transmits a video to the video display terminal (STA) 302.

FIG. 21 illustrates a state in which a video transmission terminal (STA) 401 and a video display terminal (AP) 402 perform direct video communication. The video transmission terminal (STA) 401 is connected to a wireless network 400 constructed by the video display terminal (AP) 402, and the video transmission terminal (STA) 401 transmits a video to the video display terminal (AP) 402.

Here, the following operation is performed when a new video display terminal that has not joined the wireless network 400 joins the wireless network 400 and the same video as the video transmitted by the video transmission terminal (STA) 401 to the video display terminal (AP) 402 is received and displayed.

A new video display terminal 403 serves as the STA to be connected to the video display terminal (AP) 402 constructing the wireless network 400. Here, the video transmission terminal (STA) 401 can transmit a video to a plurality of terminals within the wireless network 400 in any of unicast, multicast, and broadcast. However, when high quality and high reliability of the video are required, unicast transmission is necessary.

FIG. 22 illustrates a configuration of a wireless network and a flow of a video when the new video display terminal (STA) 403 has joined in the state illustrated in FIG. 21. When the video transmission terminal (STA) 401 transmits the same video to the plurality of terminals within the same wireless network 400 in unicast, it is necessary to separately transmit the video by setting a destination of the video for every transmission destination. In addition, when the destination of the video is the STA, the video is transmitted to the STA of the destination from the AP after the AP has received the transmitted video.

In FIG. 22, the video transmission terminal (STA) 401 transmits the video by setting the destination to the video display terminal (AP) 402 (video transmission 4011). Subsequently, the video transmission terminal (STA) 401 sets the destination to the video display terminal (STA) 403, and transmits the same video as the video transmitted in the video transmission 4011 (video transmission 4012). The video display terminal (AP) 402 receives the video and the video display terminal (AP) 402 transmits the received video to the video display terminal (STA) 403 (video transmission 4013).

FIG. 23 illustrates the video transmissions 4011, 4012, and 4013 in FIG. 22 in time series. A horizontal direction (right direction) of FIG. 23 is a direction in which time passes. First, the video transmission 4011 is performed and a video is displayed in the video display terminal (AP) 402. Subsequently, after the video transmission 4012 has been performed, the video transmission 4013 is performed and the video is displayed in the video display terminal (STA) 403. In FIGS. 22 and 23, transmission may be performed in the order of the video transmissions 4012, 4013, and 4011.

When the new video display terminal (STA) as illustrated in FIGS. 22 and 23 joins in the state illustrated in FIG. 21 and the number of video display terminals is 2, three slots are occupied to perform the video transmissions 4011, 4012, and 4013 in time series. When the number of video display terminals (STAs) is increased by 1, the video communication is performed via the AP. Thus, the occupancy time for two slots increases. When the number of video display terminals is N, 2N−1 slots are occupied. Thus, the video transmission terminal (STA) 401 transmits the same video a plurality of times and hence throughput is degraded.

In Japanese Unexamined Patent Application, First Publication No. 2010-187168, technology in which the role of the projector serving as the AP is switched to the STA if a new projector is added when a projector, which is a video display terminal, operates as the AP (when a network configuration is the same as that of FIG. 21) is disclosed. Thereby, for example, when the network configuration is the configuration of FIG. 22, the video transmission terminal 401 can serve as the AP. In this case, because the video is directly transmitted from the AP to each STA, it is possible to reduce the degradation of throughput.

### SUMMARY OF THE INVENTION

According to a first aspect of the present invention, a video display terminal includes: a wireless communication interface configured to wirelessly communicate with another terminal; a display interface configured to display a video; an operation interface configured to receive an operation of a user; and a control unit configured to cause the wireless communication interface to wirelessly transmit a video transmission request to a video transmission terminal joining a wireless network constructed by the own video display terminal if the operation interface receives a video display instruction when the own video display terminal operates as an access point (AP) constructing the wireless network, cause the display interface to display a video for the own video display terminal wirelessly transmitted from the video transmission terminal in response to the video transmission request and wirelessly received by the wireless communication interface, and cause the wireless communication interface to wirelessly transmit the video for the own video display terminal to another video display terminal joining the wireless network constructed by the own video display terminal.

According to a second aspect of the present invention, in the video display terminal according to the first aspect, when the wireless communication interface has received transmission destination information representing a transmission destination of the video for the own video display terminal, along with the video for the own video display terminal, from the video transmission terminal, the control unit may cause the wireless communication interface to wirelessly transmit the video for the own video display terminal to a video display terminal represented by the transmission destination information.

According to a third aspect of the present invention, in the video display terminal according to the first aspect, when the wireless communication interface has wirelessly received terminal information representing whether a wireless terminal is a video display terminal from the wireless terminal which has not joined the wireless network constructed by the own video display terminal and is other than the video transmission terminal, the control unit may cause the wireless communication interface to wirelessly transmit the video for the own video display terminal to only the wireless terminal wirelessly transmitting terminal information representing that the wireless terminal is the video display terminal after the wireless terminal has joined the wireless network constructed by the own video display terminal.

According to a fourth aspect of the present invention, in the video display terminal according to the first aspect, when the wireless communication interface has wirelessly received limitation information representing that a display of a video is limited, along with the video for the own video display terminal, from the video transmission terminal, the control unit may cause the wireless communication interface to wirelessly transmit the video for the own video display terminal obtained by performing image processing for degrading visibility of a video to the other video display terminal.

According to a fifth aspect of the present invention, in the video display terminal according to the second aspect, when the wireless communication interface has wirelessly received encryption information in accordance with the transmission destination represented by the transmission destination information, along with the encrypted video for the own video display terminal, from the video transmission terminal, the control unit may decrypt the encrypted video for the own video display terminal, encrypts the decrypted video for the own video display terminal based on the encryption information, and may cause the wireless communication interface to wirelessly transmit the video for the own video display terminal encrypted based on the encryption information to the other video display terminal.

According to a sixth aspect of the present invention, a video transmission terminal includes: a wireless communication interface configured to wirelessly communicate with another terminal; and a control unit configured to cause the wireless communication interface to wirelessly transmit a video to a first video display terminal when the wireless communication interface has wirelessly received a video transmission request from the first video display terminal which operates as an AP constructing a wireless network that the own video transmission terminal has joined and cause the wireless communication interface to wirelessly transmit transmission destination information representing that a transmission destination of the video for the first video display terminal is a second video display terminal to the first video display terminal along with the video for the first video display terminal if a video session with the second video display terminal other than the first video display terminal is established when a video session with the first video display terminal is established.

According to a seventh aspect of the present invention, in the video display terminal according to the sixth aspect, when the wireless communication interface has wirelessly received a video transmission request from the second video display terminal with which the video session has been established, the control unit may cause the wireless communication interface to wirelessly transmit the transmission destination information to the first video display terminal along with the video for the first video display terminal.

According to an eighth aspect of the present invention, in the video display terminal according to the sixth aspect, the control unit may cause the wireless communication interface to wirelessly transmit limitation information representing that a display of a video is limited to the first video display terminal along with the video for the first video display terminal.

According to a ninth aspect of the present invention, in the video display terminal according to the sixth aspect, the control unit may cause the wireless communication interface to wirelessly transmit encryption information in accordance with the transmission destination represented by the transmission destination information to the first video display terminal along with the video for the first video display terminal.

According to a tenth aspect of the present invention, in the video display terminal according to the sixth aspect, the control unit may permit establishment of a video session with the second video display terminal when a number of established video sessions is counted and the number of established video sessions is less than a predetermined number. The control unit may reject the establishment of the video session with the second video display terminal when the number of established video sessions is greater than or equal to the predetermined number. The control unit may permit the establishment of the video session with the second video display terminal regardless of the number of established video sessions when a video session with the first video display terminal has been established.

According to an eleventh aspect of the present invention, a video communication system includes: a first video display terminal; and a video transmission terminal joining a wireless network constructed by the first video display terminal. The first video display terminal includes: a first wireless communication interface configured to wirelessly communicate with another terminal; a display interface configured to display a video; an operation interface configured to receive an operation of a user; and a first control unit configured to cause the first wireless communication interface to wirelessly transmit a video transmission request to the video transmission terminal if the operation interface receives a video display instruction when the first video display terminal operates as an AP constructing the wireless network, cause the display interface to display a video for the first video display terminal wirelessly transmitted from the video transmission terminal in response to the video transmission request and wirelessly received by the first wireless communication interface, and cause the first wireless communication interface to wirelessly transmit the video for the first video display terminal to a second video display terminal which joins the wireless network constructed by the first video display terminal and is other than the first video display terminal. The video transmission terminal includes: a second wireless communication interface configured to wirelessly communicate with another terminal; and a second control unit configured to cause the second wireless communication interface to wirelessly transmit a video to the first video display terminal when the second wireless communication interface has wirelessly received the video transmission request from the first video display terminal and cause the second wireless communication interface to wirelessly transmit transmission destination information representing that a transmission destination of the video for the first video display terminal is a second video display terminal to the first video display terminal along with the video for the first video display terminal if a video session with the second video display terminal is established when a video session with the first video display terminal is established.

According to a twelfth aspect of the present invention, a video display method includes the steps of: wirelessly transmitting, by a wireless communication interface provided in a first video display terminal, a video transmission request to a video transmission terminal joining a wireless network constructed by the first video display terminal if an operation interface provided in the first video display terminal receives a video display instruction when the first video display terminal operates as an AP constructing the wireless network; and displaying, by a display interface, a video for the first video display terminal wirelessly transmitted from the video transmission terminal in response to the video transmission request and wirelessly received by the wireless communication interface, and wirelessly transmitting, by the wireless communication interface, the video for the first video display terminal to a second video display terminal which joins the wireless network constructed by the first video display terminal and is other than the first video display terminal.

According to a thirteenth aspect of the present invention, a video transmission method includes the steps of: wirelessly transmitting, by a wireless communication interface provided in a video transmission terminal, a video to a first video display terminal when the wireless communication interface has wirelessly received a video transmission request from the first video display terminal which operates as an AP constructing a wireless network that the video transmission terminal has joined; and wirelessly transmitting, by the wireless communication interface, transmission destination information representing that a transmission destination of the video for the first video display terminal is a second video display terminal to the first video display terminal along with the video for the first video display terminal if a video session with a second video display terminal other than the first video display terminal is established when a video session with the first video display terminal is established.

According to a fourteenth aspect of the present invention, a computer-readable recording medium records a program for causing a computer to execute the steps of: causing a wireless communication interface provided in a first video display terminal to wirelessly transmit a video transmission request to a video transmission terminal joining a wireless network constructed by the first video display terminal if an operation interface provided in the first video display terminal receives a video display instruction when the first video display terminal operates as an AP constructing the wireless network; and causing a display interface to display a video for the first video display terminal wirelessly transmitted from the video transmission terminal in response to the video transmission request and wirelessly received by the wireless communication interface and causing the wireless communication interface to wirelessly transmit the video for the first video display terminal to a second video display terminal which joins the wireless network constructed by the first video display terminal and is other than the first video display terminal.

According to a fifteenth aspect of the present invention, a computer-readable recording medium records a program for causing a computer to execute the steps of: causing a wireless communication interface provided in a video transmission terminal to wirelessly transmit a video to a first video display terminal when the wireless communication interface has wirelessly received a video transmission request from the first video display terminal which operates as an AP constructing a wireless network that the video transmission terminal has joined; and causing the wireless communication interface to wirelessly transmit transmission destination information representing that a transmission destination of the video for the first video display terminal is a second video display terminal to the first video display terminal along with the video for the first video display terminal if a video session with a second video display terminal other than the first video display terminal is established when a video session with the first video display terminal is established.

### BRIEF DESCRIPTION OF THE DRAWINGS

FIG. 1 is a block diagram illustrating a configuration of a video display terminal according to a first embodiment of the present invention.

FIG. 2 is a flowchart illustrating a procedure of an operation of the video display terminal according to the first embodiment of the present invention.

FIG. 3 is a sequence diagram illustrating operations of a video transmission terminal (STA), a video display terminal (AP), and a video display terminal (STA) in the first embodiment of the present invention.

FIG. 4 is a block diagram illustrating a configuration of a video transmission terminal according to a second embodiment of the present invention.

FIG. 5 is a flowchart illustrating a procedure of an operation of a video display terminal according to the second embodiment of the present invention.

FIG. 6 is a flowchart illustrating a procedure of an operation of the video transmission terminal according to the second embodiment of the present invention.

FIG. 7 is a sequence diagram illustrating operations of a video transmission terminal (STA), a video display terminal (AP), and a video display terminal (STA) in the second embodiment of the present invention.

FIG. 8 is a flowchart illustrating a procedure of an operation of a video transmission terminal according to a third embodiment of the present invention.

FIG. 9 is a sequence diagram illustrating operations of a video transmission terminal (STA), a video display terminal (AP), and a video display terminal (STA) in the third embodiment of the present invention.

FIG. 10 is a flowchart illustrating a procedure of an operation of a video display terminal according to a fourth embodiment of the present invention.

FIG. 11 is a sequence diagram illustrating operations of a video transmission terminal (STA), a video display terminal (AP), and a video display terminal (STA) in the fourth embodiment of the present invention.

FIG. 12 is a flowchart illustrating a procedure of an operation of a video display terminal according to a fifth embodiment of the present invention.

FIG. 13 is a flowchart illustrating a procedure of an operation of a video transmission terminal according to the fifth embodiment of the present invention.

FIG. 14 is a sequence diagram illustrating operations of a video transmission terminal (STA), a video display terminal (AP), and a video display terminal (STA) in the fifth embodiment of the present invention.

FIG. 15 is a flowchart illustrating a procedure of an operation of a video display terminal according to a sixth embodiment of the present invention.

FIG. 16 is a flowchart illustrating a procedure of an operation of a video transmission terminal according to the sixth embodiment of the present invention.

FIG. 17 is a sequence diagram illustrating operations of a video transmission terminal (STA), a video display terminal (AP), and a video display terminal (STA) in the sixth embodiment of the present invention.

FIG. 18 is a flowchart illustrating a procedure of an operation of a video transmission terminal according to a seventh embodiment of the present invention.

FIG. 19 is a sequence diagram illustrating operations of a video transmission terminal (STA), a video display terminal (AP), and video display terminals (STAs) in the seventh embodiment of the present invention.

FIG. 20 is a block diagram illustrating a relationship between the role of a wireless terminal and the roles in a video session.

FIG. 21 is a block diagram illustrating a relationship between the role of a wireless terminal and the roles in a video session.

FIG. 22 is a block diagram illustrating a configuration of a wireless network and a flow of a video when a new video display terminal has joined the wireless network.

FIG. 23 is a timing chart illustrating video transmission when the new video display terminal has joined the wireless network.

### DETAILED DESCRIPTION OF THE INVENTION

Hereinafter, embodiments of the present invention will be described with reference to the drawings. In the following embodiments, a video indicates both video data constituting the video and a video to be displayed on a display unit based on the video data. That is, both video data to be transmitted and received between a video transmission terminal and a video display terminal and a video to be displayed based on the video data in the video display terminal are referred to as the video.

### First Embodiment

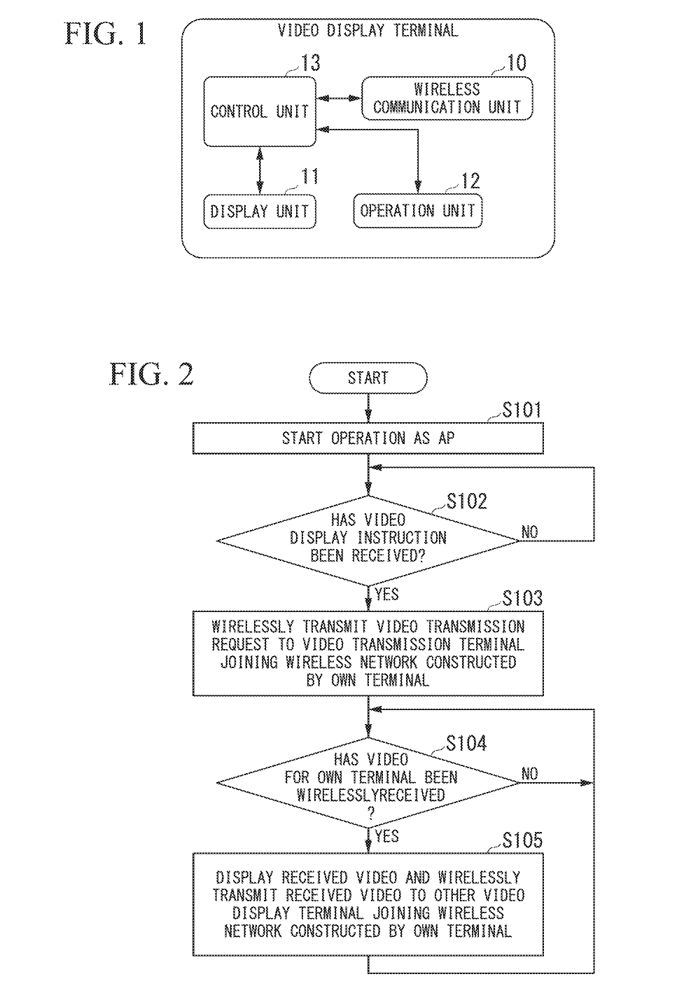

FIG. 1 illustrates a configuration of a video display terminal according to the first embodiment of the present invention. The video display terminal illustrated in FIG. 1 includes a wireless communication unit 10, a display unit 11, an operation unit 12, and a control unit 13.

The wireless communication unit 10 is a wireless communication interface, for example, a wireless communication module or a wireless communication device, configured to wirelessly communicate with another terminal. The display unit 11 is a display interface, for example, a display module or a display device, configured to display a video received by the wireless communication unit 10. The operation unit 12 is an operation interface, for example, an operation module or an operation device, configured to receive a user's operation. The control unit 13 controls each unit of the video display terminal. More specifically, if the operation unit 12 has received a video display instruction when its own terminal (first video display terminal) operates as an AP constructing the wireless network, the control unit 13 causes the wireless communication unit 10 to wirelessly transmit a video transmission request to the video transmission terminal joining a wireless network constructed by the own terminal. In addition, the control unit 13 causes the display unit 11 to display the video for the own terminal wirelessly transmitted from the video transmission terminal in response to the video transmission request and wirelessly received by the wireless communication unit 10. In addition, the control unit 13 causes the wireless communication unit 10 to wirelessly transmit the video for the own terminal to another video display terminal (a second video display terminal which joins the wireless network constructed by the first video display terminal and is other than the first display terminal) joining the wireless network constructed by the own terminal.

A function of the control unit 13 can be implemented as a function of software by causing a computer (central processing unit (CPU)) of the video display terminal to read and execute a program stored in a storage unit (not illustrated). In addition, the program, for example, may be provided through a “computer-readable recording medium” such as a flash memory. In addition, the above-described program may be input to the video display terminal by transmitting the program from the computer storing the program in a storage device or the like to the video display terminal via a transmission medium or transmission waves of the transmission medium. Here, the “transmission medium” for transmitting the program refers to a medium having a function of transmitting information, for example, a network (communication network) such as the Internet or a communication circuit (communication line) such as a telephone circuit. In addition, the above-described program may be used to implement some of the above-described functions. Further, the program may be a so-called differential file (differential program) capable of implementing the above-described functions in combination with a program already recorded on the computer system.

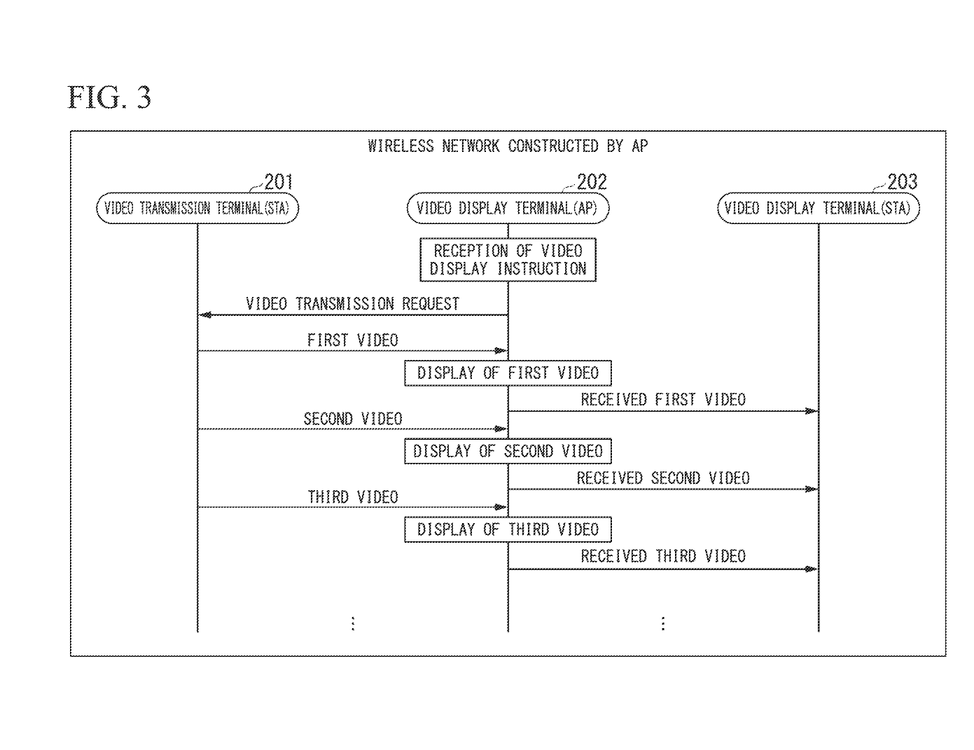

FIG. 2 illustrates an operation of the video display terminal. Hereinafter, the operation of the video display terminal will be described. The video display terminal starts an operation as the AP (step S101). At this time, the control unit 13 causes the wireless communication unit 10 to construct a wireless network. The wireless communication unit 10 constructs the wireless network. The construction of the wireless network is performed by generating a service set ID (SSID) which is an identifier of the wireless network and a pass phrase which is an encryption key.

Subsequently, the control unit 13 monitors a state of the operation unit 12 and determines whether the operation unit 12 has received a video display instruction (step S102). When the operation unit 12 has not received the video display instruction, the control unit 13 continues to monitor the state of the operation unit 12. When the operation unit 12 has received the video display instruction, the wireless communication unit 10 wirelessly transmits the video transmission request to the video transmission terminal joining the wireless network constructed by the own terminal (step S103). At this time, the control unit 13 causes the wireless communication unit 10 to wirelessly transmit the video transmission request to the video transmission terminal joining the wireless network constructed by the own terminal. The video transmission request is a message representing that video transmission is requested. According to a process (not illustrated), a video session between the video display terminal and the video transmission terminal is established and therefore the video display terminal can be aware of the presence of the video transmission terminal.

After the video transmission request has been wirelessly transmitted, the control unit 13 monitors the state of the wireless communication unit 10 and determines whether the video for the own terminal has been wirelessly received (step S104). When the video for the own terminal has not been wirelessly received, the control unit 13 continues to monitor the state of the wireless communication unit 10. When the video for the own terminal from the video transmission terminal has been wirelessly transmitted in response to the video transmission request, the wireless communication unit 10 wirelessly receives the video for the own terminal. At this time, the control unit 13 causes the wireless communication unit 10 to wirelessly receive the video for the own terminal wirelessly transmitted from the video transmission terminal in response to the video transmission request.

When the video for the own terminal has been wirelessly received, the display unit 11 displays the received video. The wireless communication unit 10 wirelessly transmits the video for the own terminal to another video display terminal joining the wireless network constructed by the own terminal (step S105). At this time, the control unit 13 causes the display unit 11 to display the video for the own terminal wirelessly transmitted from the video transmission terminal in response to the video transmission request and wirelessly received by the wireless communication unit 10. Also, the control unit 13 causes the wireless communication unit 10 to wirelessly transmit the video for the own terminal to another video display terminal joining the wireless network constructed by the own terminal. According to a process (not illustrated), the video display terminal can be aware of the presence of another video display terminal by receiving a connection request from the other video display terminal which is not connected to the wireless network. The connection request is a message representing a request for a connection to a terminal serving as a connection partner.

Step S105 may be divided into the step in which the display unit 11 displays the received video and the step in which the wireless communication unit 10 wirelessly transmits the video for the own terminal to the other video display terminal joining the wireless network constructed by the own terminal. In this case, any of the display of the video and the wireless transmission of the video may be performed first.

After the video has been wirelessly transmitted, the process of step S104 is performed.

FIG. 3 illustrates operations of a video transmission terminal (STA) 201, a video display terminal (AP) 202, and a video display terminal (STA) 203 in the wireless network. Each terminal joins the wireless network constructed by the video display terminal (AP) 202.

The video display terminal (AP) 202 receives a video display instruction (corresponding to step S102). Then, the video display terminal (AP) 202 wirelessly transmits the video transmission request to the video transmission terminal (STA) 201 (corresponding to step S103). The video transmission terminal (STA) 201 wirelessly receives the video transmission request, and wirelessly transmits first, second, and third videos for the video display terminal (AP) 202 to the video display terminal (AP) 202 in order at predetermined intervals. The video display terminal (AP) 202 wirelessly receives the first video, causes the display unit 11 to display the first video, and wirelessly transmits the first video to the video display terminal (STA) 203 (corresponding to steps S104 and S105). The video display terminal (AP) 202 sequentially performs similar processes on the second and third videos.

In FIG. 3, the video transmission terminal (STA) 201, for example, is a PC. The video display terminal (AP) 202, for example, is a TV. The video display terminal (STA) 203, for example, is a smartphone. For example, while the TV displays the video wirelessly transmitted from the PC by applying this embodiment, the smartphone present in a room or the like different from a room in which the TV is arranged can display the same video.

According to this embodiment, a video display terminal includes: a wireless communication interface (wireless communication unit 10) configured to wirelessly communicate with another terminal; a display interface (display unit 11) configured to display a video; an operation interface (operation unit 12) configured to receive an operation of a user; and a control unit configured to cause the wireless communication interface to wirelessly transmit a video transmission request to the video transmission terminal joining a wireless network constructed by the own video display terminal if the operation interface receives a video display instruction when the own video display terminal operates as an access point (AP) constructing the wireless network, cause the display interface to display a video for the own terminal wirelessly transmitted from the video transmission terminal in response to the video transmission request and wirelessly received by the wireless communication interface, and cause the wireless communication interface to wirelessly transmit the video for the own video display terminal to another video display terminal joining the wireless network constructed by the own video display terminal.

In addition, according to this embodiment, a video display method includes: step S103 of wirelessly transmitting, by a wireless communication interface (wireless communication unit 10) provided in a first video display terminal, a video transmission request to a video transmission terminal joining a wireless network constructed by the first video display terminal if an operation interface (operation unit 12) provided in the first video display terminal receives a video display instruction when the first video display terminal operates as an AP constructing the wireless network; and step S105 of displaying, by a display interface (display unit 11), a video for the first video display terminal wirelessly transmitted from the video transmission terminal in response to the video transmission request and wirelessly received by the wireless communication interface and wirelessly transmitting, by the wireless communication interface, the video for the first video display terminal to a second video display which joins the wireless network constructed by the first video display terminal and is other than the first video display terminal.

In addition, according to this embodiment, a program is provided for causing a computer to execute: step S103 of causing a wireless communication interface (wireless communication unit 10) provided in a first video display terminal to wirelessly transmit a video transmission request to a video transmission terminal joining a wireless network constructed by the first video display terminal if an operation interface (operation unit 12) provided in the first video display terminal receives a video display instruction when the first video display terminal operates as an AP constructing the wireless network; and step S105 of causing a display interface (display unit 11) to display a video for the first video display terminal wirelessly transmitted from the video transmission terminal in response to the video transmission request and wirelessly received by the wireless communication interface and causing the wireless communication interface to wirelessly transmit the video for the first video display terminal to a second video display terminal which joins the wireless network constructed by the first video display terminal and is other than the first video display terminal.

In this embodiment, when the video transmission terminal and another video display terminal have joined the wireless network constructed by the video display terminal operating as the AP, the video display terminal operating as the AP wirelessly transmits the video, which is wirelessly transmitted from the video transmission terminal to the video display terminal itself, to the other video display terminal. Therefore, it is possible to reduce the degradation of throughput when the video is transmitted from the video transmission terminal to the other video display terminal without causing a disconnection of the network.

### Second Embodiment

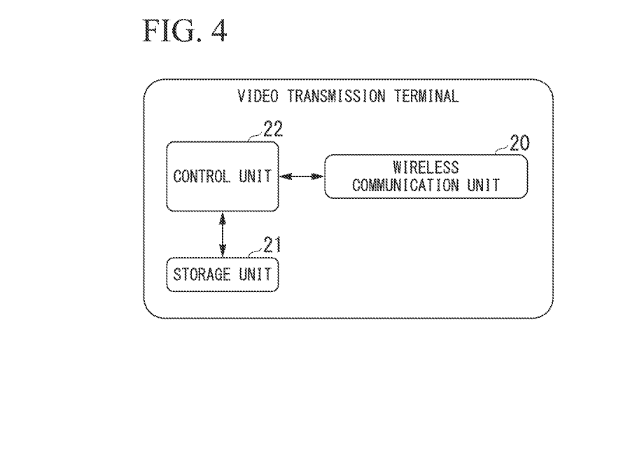

Next, the second embodiment of the present invention will be described. FIG. 4 illustrates a configuration of a video transmission terminal according to this embodiment. The video transmission terminal illustrated in FIG. 4 includes a wireless communication unit 20, a storage unit 21, and a control unit 22.

The wireless communication unit 20 is a wireless communication interface, for example, a wireless communication module or a wireless communication device, configured to wirelessly communicate with another terminal. The storage unit 21 is a storage module, for example, a storage device, having a storage medium such as a memory or buffer for storing a video or various types of information. The storage unit 21 is not an essential configuration for obtaining an effect of reducing the degradation of throughput when the video is transmitted from the video transmission terminal without causing a disconnection of the network. The video transmission terminal may include the storage unit 21 if necessary.

The control unit 22 controls each unit of the video transmission terminal. More specifically, the control unit 22 causes the wireless communication unit 20 to wirelessly transmit a video to a first video display terminal when the wireless communication unit 20 has wirelessly received a video transmission request from the first video display terminal which operates as an AP constructing a wireless network that its own terminal has joined. In addition, the control unit 22 causes the wireless communication unit 20 to wirelessly transmit transmission destination information to the first video display terminal along with the video for the first video display terminal if a video session with the second video display terminal other than the first video display terminal is established when a video session with the first video display terminal is established. At this time, the transmission destination information is information representing that the transmission destination of the video for the first video display terminal is the second video display terminal.

The transmission destination information, for example, is a media access control (MAC) address. Information representing the destination of the packet including the video is information (for example, a MAC address) of a single terminal. The transmission destination information is added to a packet including a video as additional information separately from information representing this destination.

A function of the control unit 22 can be implemented as a function of software by causing a computer (CPU) of the video transmission terminal to read and execute a program stored in a storage unit (not illustrated). In addition, the program, for example, may be provided through a “computer-readable recording medium” such as a flash memory. In addition, the above-described program may be input from the computer storing the program in a storage device or the like to the video transmission terminal via a transmission medium. Alternatively, the above-described program may be input to the video transmission terminal by transmitting the program from the computer storing the program in a storage device or the like to the video transmission terminal via transmission waves of the transmission medium. Here, the “transmission medium” for transmitting the program refers to a medium having a function of transmitting information, for example, a network (communication network) such as the Internet or a communication circuit (communication line) such as a telephone circuit. In addition, the above-described program may be used to implement some of the above-described functions. Further, the program may be a so-called differential file (differential program) capable of implementing the above-described functions in combination with a program already recorded on the computer system.

The configuration of the video display terminal according to this embodiment is the same as that illustrated in FIG. 1. In this embodiment, the control unit 13 causes the wireless communication unit 10 to wirelessly transmit the video for the own terminal to the video display terminal represented by the transmission destination information when the wireless communication unit 10 has wirelessly received the transmission destination information representing the transmission destination of the video for the own terminal, along with the video for the own terminal, from the video transmission terminal.

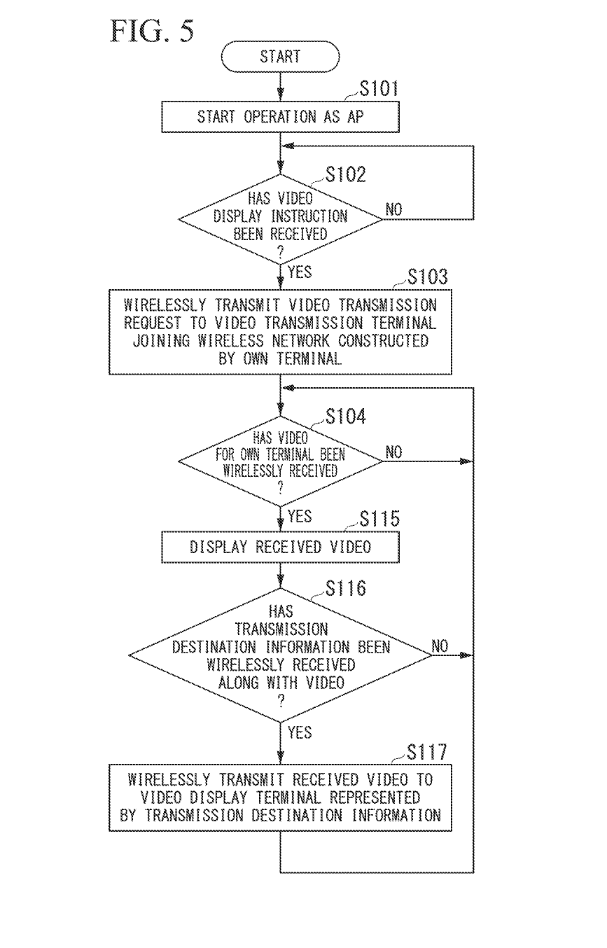

FIG. 5 illustrates the operation of the video display terminal. Hereinafter, parts of the operation of the video display terminal different from the operation illustrated in FIG. 2 will be described.

When the video for the own terminal has been wirelessly received in step S104, the display unit 11 displays the received video (step S115). At this time, the control unit 13 causes the display unit 11 to display the video for the own terminal wirelessly transmitted from the video transmission terminal in response to the video transmission request and wirelessly received by the wireless communication unit 10.

After the video has been displayed, the control unit 13 determines whether the transmission destination information has been wirelessly received along with the video (step S116). When the transmission destination information has not been wirelessly received along with the video for the own terminal in step S104, the process of step S104 is performed. When the transmission destination information has been wirelessly transmitted along with the video for the own terminal from the video transmission terminal in response to the video transmission request, the wireless communication unit 10 wirelessly receives the transmission destination information along with the video for the own terminal. At this time, the control unit 13 causes the wireless communication unit 10 to wirelessly receive the transmission destination information along with the video for the own terminal wirelessly transmitted from the video transmission terminal in response to the video transmission request.

When the transmission destination information has been wirelessly received along with the video, the wireless communication unit 10 wirelessly transmits the video for the own terminal to the video display terminal represented by the transmission destination information (step S117). At this time, the control unit 13 causes the wireless communication unit 10 to wirelessly transmit the video for the own terminal to the video display terminal represented by the transmission destination information. After the video has been wirelessly transmitted to the wireless communication unit 10, the process of step S104 is performed.

Although the video is wirelessly transmitted after the video has been displayed in the operation illustrated in FIG. 5, the video may be displayed after the video has been wirelessly transmitted. For example, when the video for the own terminal has been wirelessly received in step S104, a determination is performed in step S116. When it is determined that the transmission destination information has been wirelessly received in step S116, the video is displayed in step S115 after the video has been wirelessly transmitted in step S117. When it is determined that the transmission destination information has not been wirelessly received in step S116, the video is displayed in step S115.

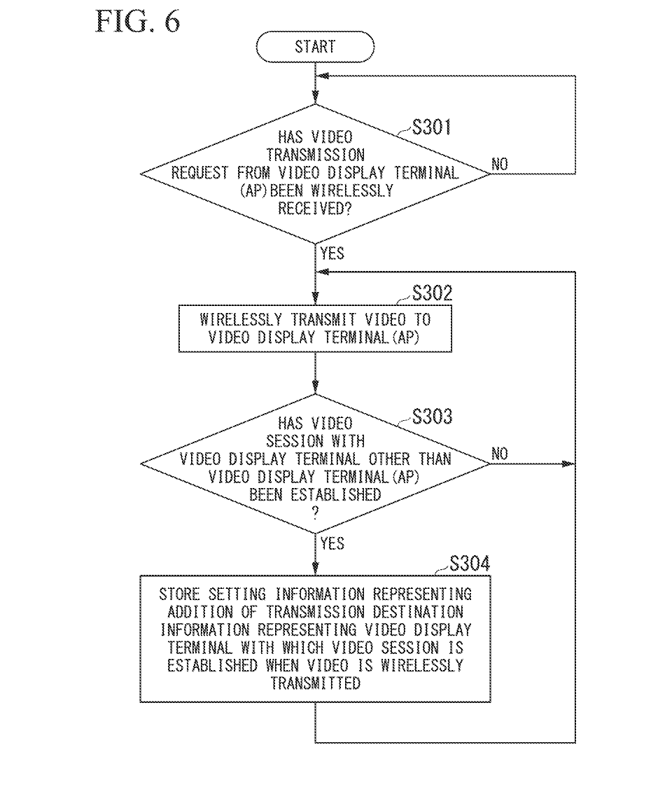

FIG. 6 illustrates an operation of the video transmission terminal. Hereinafter, the operation of the video transmission terminal will be described.

The control unit 22 monitors the state of the wireless communication unit 20, and determines whether the video transmission request from the video display terminal (AP) has been wirelessly received (step S301). When the video transmission request has not been wirelessly received from the video display terminal (AP), the control unit 22 continues to monitor the state of the wireless communication unit 20. When the video transmission request has been wirelessly transmitted from the video display terminal (AP), the wireless communication unit 20 wirelessly receives the video transmission request from the video display terminal (AP). At this time, the control unit 22 causes the wireless communication unit 20 to wirelessly receive the video transmission request from the video display terminal (AP).

When the video transmission request from the video display terminal (AP) has been wirelessly received, the wireless communication unit 20 wirelessly transmits the video stored in the storage unit 21 to the video display terminal (AP) (step S302). At this time, the control unit 22 causes the wireless communication unit 20 to wirelessly transmit the video stored in the storage unit 21 to the video display terminal (AP). The process of step S302 is iterated at a predetermined interval. The timing of wireless transmission in step S302 is not influenced by the execution of steps S303 and S304.

Before the video is wirelessly transmitted to the video display terminal (AP) in step S302, a video session is established between the video transmission terminal and the video display terminal (AP) according to a process (not illustrated). The establishment of the video session may start from the video transmission terminal or start from the video display terminal. In the establishment of the video session, a determination of a video or sound format to be used between the video transmission terminal and the video display terminal or the like is made. The video transmission terminal and the video display terminal mutually hold determined information.

After the video has been wirelessly transmitted, the control unit 22 determines whether the video session with the video display terminal other than the video display terminal (AP) has been established (step S303). When the video session with the video display terminal other than the video display terminal (AP) has not been established, the process of step S302 is performed. When the video session with the video display terminal other than the video display terminal (AP) has been established, the control unit 22 causes the storage unit 21 to store setting information representing addition of transmission destination information representing the video display terminal with which the video session has been established when the video is transmitted in a subsequent process (step S304).

Every time the video session with the video display terminal other than the video display terminal (AP) is established, information of the video display terminal with which the video session has been newly established is added to the transmission destination information in step S304. For example, when the video session with two video display terminals other than the video display terminal (AP) is established, the transmission destination information represented by the setting information includes information of two video display terminals. A process of storing the setting information in step S304 is not an essential process for obtaining an effect of reducing the degradation of throughput at the time of video transmission from the video transmission terminal without causing a disconnection of the network.

After the setting information has been stored in the storage unit 21, the process of step S302 is performed. When the process of step S304 has been performed, the wireless communication unit 20 wirelessly transmits the transmission destination information to the video display terminal (AP) along with the video stored in the storage unit 21 in step S302. In addition, the setting information and the video are stored in the storage unit 21. In step S302, the control unit 22 causes the wireless communication unit 20 to wirelessly transmit the transmission destination information to the video display terminal (AP) along with the video according to the setting information.

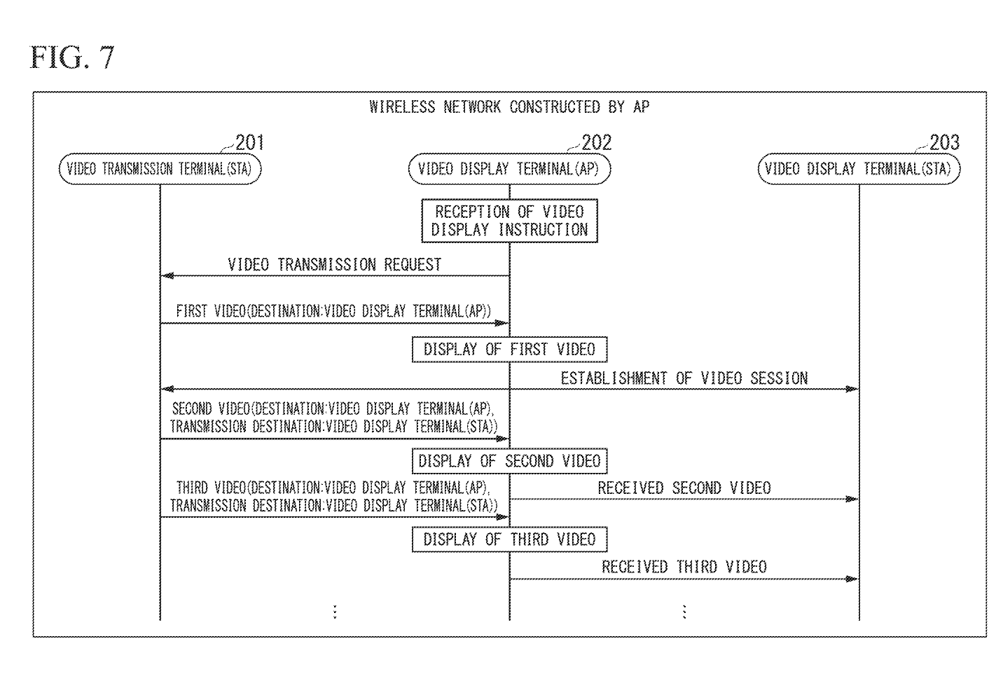

FIG. 7 illustrates operations of a video transmission terminal (STA) 201, a video display terminal (AP) 202, and a video display terminal (STA) 203 in the wireless network. Each terminal joins the wireless network constructed by the video display terminal (AP) 202. The video session is established between the video transmission terminal (STA) 201 and the video display terminal (AP) 202.

When the video display terminal (AP) 202 receives the video display instruction (corresponding to step S102), the video display terminal (AP) 202 wirelessly transmits the video transmission request to the video transmission terminal (STA) 201 (corresponding to step S103). The video transmission terminal (STA) 201 wirelessly receives the video transmission request (corresponding to step S301). The video transmission terminal (STA) 201 wirelessly transmits the first video for the video display terminal (AP) 202 to the video display terminal (AP) 202 (corresponding to step S302). The video display terminal (AP) 202 wirelessly receives the first video and causes the display unit 11 to display the first video (corresponding to steps S104 and S115).

Thereafter, the video session between the video transmission terminal (STA) 201 and the video display terminal (STA) 203 is established. After the video session has been established, the video transmission terminal (STA) 201 wirelessly transmits the second video for the video display terminal (AP) 202 and the transmission destination information representing that the transmission destination is the video display terminal (STA) 203 to the video display terminal (AP) 202 (corresponding to steps S304 and S302). The video display terminal (AP) 202 receives the second video and the transmission destination information and causes the display unit 11 to display the second video (corresponding to steps S104 and S115), and wirelessly transmits the second video to the video display terminal (STA) 203 according to the transmission destination information (corresponding to step S117). Thereafter, the video transmission terminal (STA) 201 and the video display terminal (AP) 202 perform a process similar to a process performed on the second video for the third video.

According to this embodiment, a video transmission terminal includes: a wireless communication interface (wireless communication unit 20) configured to wirelessly communicate with another terminal; and a control unit 22 configured to cause the wireless communication interface to wirelessly transmit a video to a first video display terminal when the wireless communication interface has wirelessly received a video transmission request from the first video display terminal which operates as an access point (AP) constructing a wireless network that the own video display terminal has joined and cause the wireless communication interface to wirelessly transmit transmission destination information representing that a transmission destination of the video for the first video display terminal is a second video display terminal to the first video display terminal along with the video for the first video display terminal if a video session with the second video display terminal other than the first video display terminal is established when a video session with the first video display terminal is established.

In addition, according to this embodiment, a video communication system includes a first video display terminal and a video transmission terminal joining a wireless network constructed by the first video display terminal, and the first video display terminal includes: a first wireless communication interface (wireless communication unit 10) configured to wirelessly communicate with another terminal; a display interface (display unit 11) configured to display a video; an operation interface (operation unit 12) configured to receive an operation of a user; and a first control unit (control unit 13) configured to cause the first wireless communication interface to wirelessly transmit a video transmission request to the video transmission terminal if the operation interface receives a video display instruction when the first video display terminal operates as an AP constructing the wireless network, cause the display interface to display the video for the first video display terminal wirelessly transmitted from the video transmission terminal in response to the video transmission request and wirelessly received by the first wireless communication interface, and cause the first wireless communication interface to wirelessly transmit the video for the first video display terminal to a second video display terminal which joins the wireless network constructed by the first video display terminal and is other than the first video display terminal.

In addition, the video transmission terminal in the video communication system according to this embodiment includes: a second wireless communication interface (wireless communication section 20) configured to wirelessly communicate with another terminal; and a second control unit (control unit 22) configured to cause the second wireless communication interface to wirelessly transmit a video to the first video display terminal when the second wireless communication interface has wirelessly received the video transmission request from the first video display terminal and cause the second wireless communication interface to wirelessly transmit transmission destination information representing that a transmission destination of the video for the first video display terminal is a second video display terminal to the first video display terminal along with the video for the first video display terminal if a video session with the second video display terminal is established when a video session with the first video display terminal is established.

In addition, according to this embodiment, a video transmission method includes: step S302 of wirelessly transmitting, by a wireless communication interface (wireless communication unit 20) provided in a video transmission terminal, a video to a first video display terminal when the wireless communication interface has wirelessly received a video transmission request from the first video display terminal which operates as an AP constructing a wireless network that the video transmission terminal has joined; and step S302 of wirelessly transmitting, by the wireless communication interface, transmission destination information representing that a transmission destination of the video for the first video display terminal is a second video display terminal to the first video display terminal along with the video for the first video display terminal if a video session with a second video display terminal other than the first video display terminal is established when a video session with the first video display terminal is established.

In addition, according to this embodiment, a program is provided for causing a computer to execute: step S302 of causing a wireless communication interface (wireless communication unit 20) provided in a video transmission terminal to wirelessly transmit a video to a first video display terminal when the wireless communication interface has wirelessly received a video transmission request from the first video display terminal which operates as an AP constructing a wireless network that the video transmission terminal has joined; and step S302 of causing the wireless communication interface to wirelessly transmit transmission destination information representing that a transmission destination of the video for the first video display terminal is a second video display terminal to the first video display terminal along with the video for the first video display terminal if a video session with a second video display terminal other than the first video display terminal is established when a video session with the first video display terminal is established.

In this embodiment, because the transmission destination of the video is only a video display terminal establishing the video session with the video transmission terminal, it is possible to omit ineffective wireless transmission of the video as compared to the first embodiment. Thus, as compared to the first embodiment, it is possible to further reduce the degradation of throughput at the time of video transmission from the video transmission terminal to each video display terminal.

### Third Embodiment

Next, the third embodiment of the present invention will be described. A configuration of a video display terminal according to this embodiment is the same as that illustrated in FIG. 1.

A configuration of a video transmission terminal according to this embodiment is the same as that illustrated in FIG. 4. In this embodiment, when the wireless communication unit 20 has wirelessly received a video transmission request from a second video display terminal establishing a video session, the control unit 22 causes a wireless communication unit 20 to wirelessly transmit transmission destination information to a first video display terminal along with a video for the first video display terminal which operates as an AP.

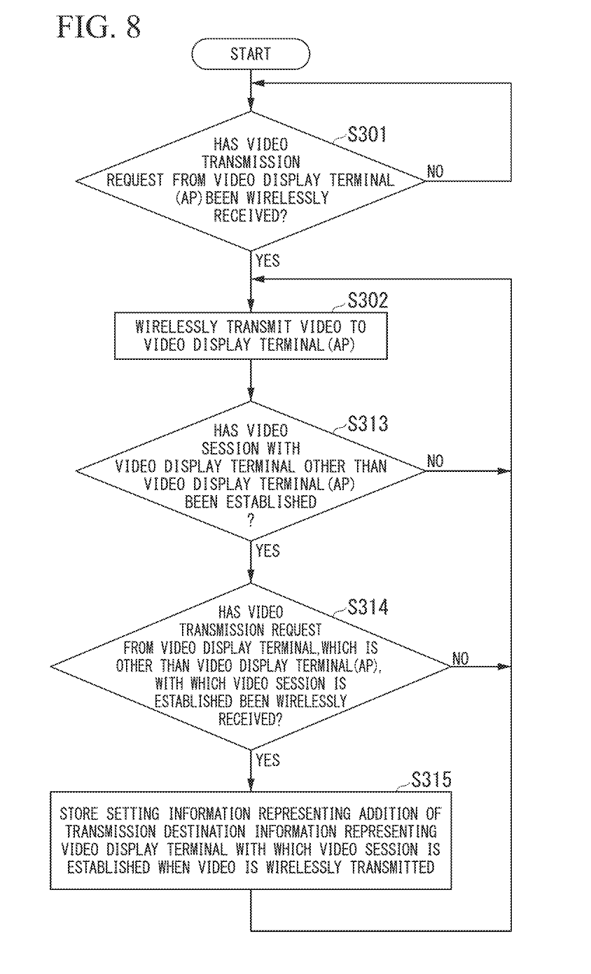

An operation of the video display terminal is the same as that illustrated in FIG. 5. FIG. 8 illustrates an operation of the video transmission terminal. Hereinafter, parts different from the operation illustrated in FIG. 6 will be described for the operation of the video transmission terminal.

After the video has been wirelessly transmitted in step S302, the control unit 22 determines whether a video session with the video display terminal other than the video display terminal (AP) has been established (step S313). At this time, the video display terminal with which the video session with the video transmission terminal has been established is specified. When the video session with the video display terminal other than the video display terminal (AP) has not been established, the process of step S302 is performed.

When the video session with the video display terminal other than the video display terminal (AP) has been established, the control unit 22 monitors a state of the wireless communication unit 20 and determines whether the video transmission request has been wirelessly received from the video display terminal with which the video session has been established other than the video display terminal (AP) (step S314). At this time, it is also checked whether a transmission source of the wirelessly received video transmission request is the video display terminal specified in step S313. When the video transmission request from the video display terminal has not been wirelessly received, the process of step S302 is performed. When the video transmission request has been wirelessly transmitted from the video display terminal, the wireless communication unit 20 wirelessly receives the video transmission request from the video display terminal. At this time, the control unit 22 causes the wireless communication unit 20 to wirelessly receive the video transmission request from the video display terminal.

When the video transmission request from the video display terminal has been wirelessly received, the control unit 22 causes the storage unit 21 to store setting information representing addition of transmission destination information representing a video display terminal with which a video session has been established when the video is wirelessly transmitted in a subsequent process (step S315). A process of storing the setting information in step S315 is not an essential process for obtaining an effect of reducing the degradation of throughput at the time of video transmission from the video transmission terminal without causing a disconnection of the network.

After the setting information has been stored in the storage unit 21, the process of step S302 is performed. When the process of step S315 has been performed, the wireless communication unit 20 wirelessly transmits the transmission destination information to the video display terminal (AP) along with the video stored in the storage unit 21 in step S302. In addition, in step S302, the control unit 22 causes the wireless communication unit 20 to wirelessly transmit the transmission destination information to the video display terminal (AP) along with the video stored in the storage unit 21 according to the setting information stored in the storage unit 21.

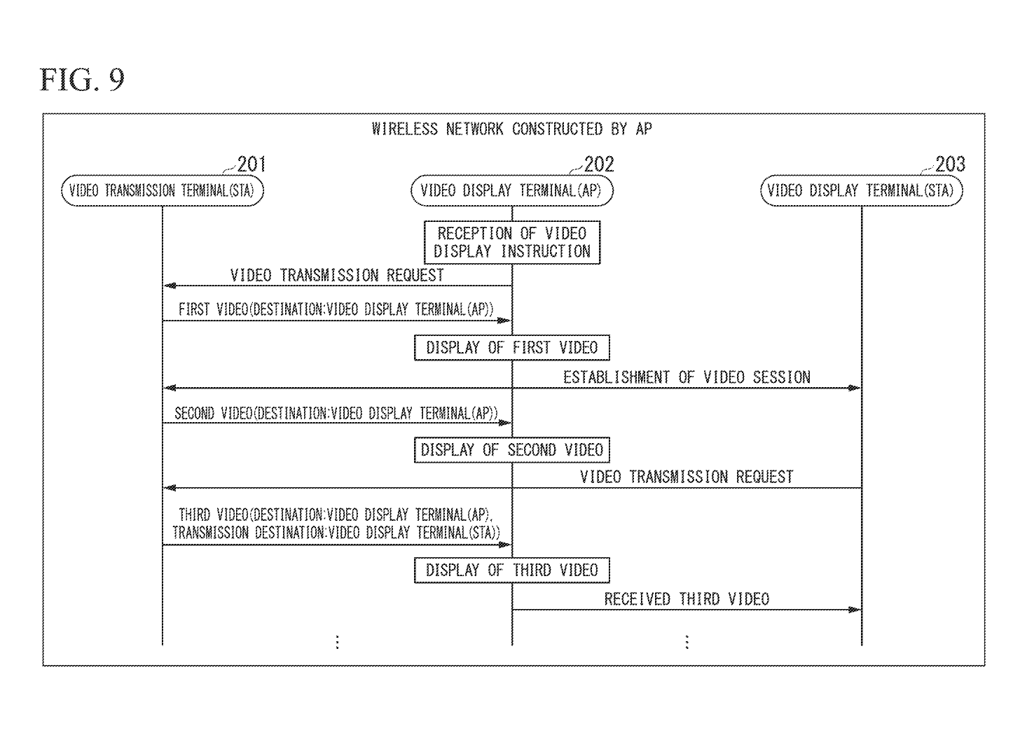

FIG. 9 illustrates operations of a video transmission terminal (STA) 201, a video display terminal (AP) 202, and a video display terminal (STA) 203 in the wireless network. Each terminal joins the wireless network constructed by the video display terminal (AP) 202. The video session is established between the video transmission terminal (STA) 201 and the video display terminal (AP) 202.

When the video display terminal (AP) 202 receives the video display instruction (corresponding to step S102), the video display terminal (AP) 202 wirelessly transmits the video transmission request to the video transmission terminal (STA) 201 (corresponding to step S103). The video transmission terminal (STA) 201 wirelessly receives the video transmission request (corresponding to step S301) and wirelessly transmits a first video for the video display terminal (AP) 202 to the video display terminal (AP) 202 (corresponding to step S302). The video display terminal (AP) 202 wirelessly receives the first video and causes the display unit 11 to display the first video (corresponding to steps S104 and S115).

Thereafter, the video session between the video transmission terminal (STA) 201 and the video display terminal (STA) 203 is established. After the video session has been established, the video transmission terminal (STA) 201 wirelessly transmits a second video for the video display terminal (AP) 202 to the video display terminal (AP) 202 (corresponding to step S302). The video display terminal (AP) 202 wirelessly receives the second video and causes the display unit 11 to display the second video (corresponding to steps S104 and S115).

Thereafter, the video display terminal (STA) 203 wirelessly transmits the video transmission request to the video transmission terminal (STA) 201. The video transmission terminal (STA) 201 wirelessly receives the video transmission request (corresponding to step S314), and wirelessly transmits a third video for the video display terminal (AP) 202 and transmission destination information representing that a transmission destination is the video display terminal (STA) 203 to the video display terminal (AP) 202 (corresponding to steps S315 and S302). The video display terminal (AP) 202 receives the third video and the transmission destination information to cause the display unit 11 to display the third video (corresponding to steps S104 and S115), and wirelessly transmits the third video to the video display terminal (STA) 203 according to the transmission destination information (corresponding to step S117).

In the operation illustrated in FIG. 9, the video session between the video transmission terminal (STA) 201 and the video display terminal (STA) 203 is established after the video display terminal 202 has received the video display instruction. However, the video session between the video transmission terminal (STA) 201 and the video display terminal (STA) 203 may be established before the video display terminal 202 receives the video display instruction.

In this embodiment, the transmission destination of the video is only a video display terminal wirelessly transmitting the video transmission request to the video transmission terminal among video display terminals establishing the video session with the video transmission terminal. Thus, it is possible to omit ineffective wireless transmission of a video as compared to the second embodiment. As a result, as compared to the second embodiment, it is possible to further reduce the degradation of throughput at the time of video transmission from the video transmission terminal to each video display terminal.

### Fourth Embodiment

Next, the fourth embodiment of the present invention will be described. A configuration of a video display terminal according to this embodiment is the same as that illustrated in FIG. 1. In this embodiment, when the wireless communication unit 10 has wirelessly received terminal information representing whether a wireless terminal is a video display terminal from the wireless terminal which has not joined a wireless network constructed by its own terminal and is other than a video transmission terminal, the control unit 22 causes the wireless communication unit 10 to wirelessly transmit a video for the own terminal to only a wireless terminal wirelessly transmitting the terminal information representing that the wireless terminal is the video display terminal after the wireless terminal has joined the wireless network constructed by the own terminal.

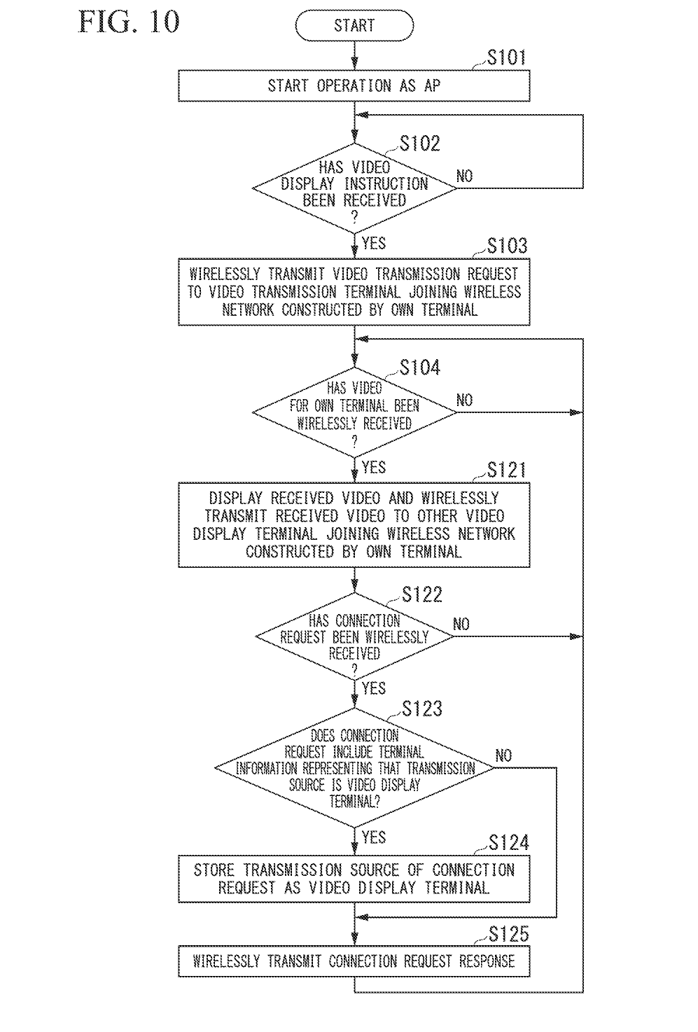

FIG. 10 illustrates an operation of the video display terminal. Hereinafter, parts of the operation of the video display terminal different from the operation illustrated in FIG. 2 will be described.

When the video for the own terminal has been wirelessly received in step S104, the display unit 11 displays the received video and the wireless communication unit 10 wirelessly transmits the video for the own terminal to another video display terminal joining the wireless network constructed by the own terminal (step S121). At this time, the control unit 13 causes the display unit 11 to display the video for the own terminal wirelessly transmitted from the video transmission terminal in response to a video transmission request and wirelessly received by the wireless communication unit 10, and causes the wireless communication unit 10 to wirelessly transmit the video for the own terminal to the other video display terminal joining the wireless network constructed by the own terminal. The video display terminal stored in step S124 to be described later serves as a transmission destination of the video wirelessly transmitted in step S121. When the video display terminal is not stored, no video is wirelessly transmitted in step S121.

Step 121 may be divided into the step in which the display unit 11 displays the received video and the step in which the wireless communication unit 10 wirelessly transmits the video for the own terminal to the other video display terminal joining the wireless network constructed by the own terminal. In this case, any of the display of the video and the wireless transmission of the video may be performed first.

After the video has been wirelessly transmitted, the control unit 13 monitors the state of the wireless communication unit 10 and determines whether a connection request has been wirelessly received (step S122). When the connection request has not been wirelessly received, the process of step S104 is performed. When the connection request has been wirelessly transmitted from a wireless terminal which has not joined the wireless network constructed by the own terminal and is other than the video transmission terminal, the wireless communication unit 10 wirelessly receives the connection request. At this time, the control unit 13 causes the wireless communication unit 10 to wirelessly receive the connection request wirelessly transmitted from the wireless terminal which has not joined the wireless network constructed by the own terminal and is other than the video transmission terminal.

When the connection request has been wirelessly received, the control unit 13 determines whether the received connection request includes terminal information representing that a transmission source is a video display terminal (step S123). The terminal information is information representing whether a wireless terminal, which is the transmission source of the connection request, is the video display terminal. When the received connection request does not include the terminal information representing that the transmission source is the video display terminal, the process of step S125 is performed.

When the received connection request includes the terminal information representing that the transmission source is the video display terminal, the control unit 13 stores the transmission source of the received connection request as the video display terminal (step S124). At this time, for example, a MAC address included in the connection request is stored as information representing the transmission source of the connection request. A process of storing the transmission source in step S124 is not an essential process for obtaining an effect of reducing the degradation of throughput at the time of video transmission from the video transmission terminal without causing a disconnection of the network.

After the transmission source of the connection request has been stored, the wireless communication unit 10 wirelessly transmits a connection request response to the transmission source of the connection request (step S125). At this time, the control unit 13 causes the wireless communication unit 10 to wirelessly transmit the connection request response to the transmission source of the connection request.

The connection request response is a message representing the response to the connection request. The connection request response includes a status (a reason for failure or success) of a requested connection. The wireless terminal receiving the connection request response including the status representing the success joins the wireless network. The wireless terminal receiving the connection request response including the status representing the failure does not join the wireless network.

After the connection request response has been wirelessly transmitted, the process of step S104 is performed. When the process of step S124 has been performed, the video is wirelessly transmitted from the video display terminal (AP) to only a video display terminal wirelessly transmitting the connection request to the video display terminal (AP) among terminals joining the wireless network constructed by the video display terminal (AP) in step S121.

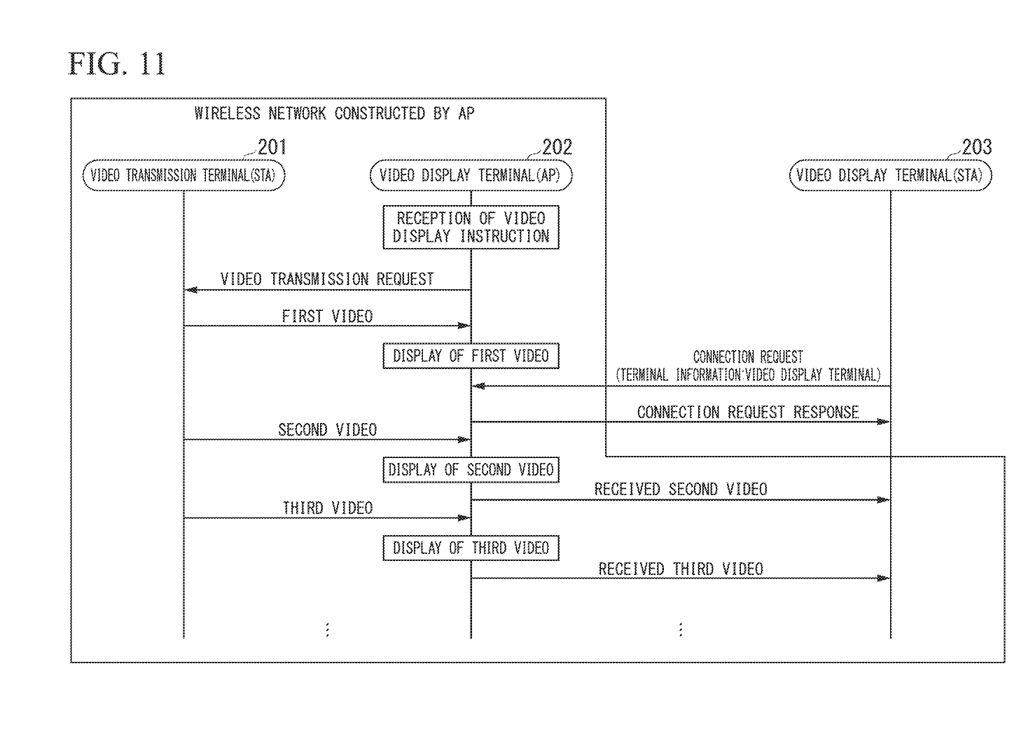

FIG. 11 illustrates operations of a video transmission terminal (STA) 201, a video display terminal (AP) 202, and a video display terminal (STA) 203 in the wireless network. The video transmission terminal (STA) 201 and the video display terminal (AP) 202 join the wireless network constructed by the video display terminal (AP) 202. At a point in time at which an operation illustrated in FIG. 11 has started, the video display terminal (STA) 203 does not join the wireless network constructed by the video display terminal (AP) 202.

When the video display terminal (AP) 202 receives the video display instruction (corresponding to step S102), the video display terminal (AP) 202 wirelessly transmits the video transmission request to the video transmission terminal (STA) 201 (corresponding to step S103). The video transmission terminal (STA) 201 wirelessly receives the video transmission request and wirelessly transmits a first video for the video display terminal (AP) 202 to the video display terminal (AP) 202. The video display terminal (AP) 202 wirelessly receives the first video and causes the display unit 11 to display the first video (corresponding to steps S104 and S121).

Thereafter, the video display terminal (STA) 203 wirelessly transmits the connection request including the terminal information representing that the transmission source is the video display terminal to the video display terminal (AP) 202. The video display terminal (AP) 202 wirelessly receives the connection request (corresponding to step S122), and stores the transmission source of the connection request as the video display terminal (corresponding to step S124). Subsequently, the video display terminal (AP) 202 wirelessly transmits a connection request response to the video display terminal (STA) 203 (corresponding to step S125). The video display terminal (STA) 203 wirelessly receives the connection request response and joins the wireless network constructed by the video display terminal (AP) 202.

Thereafter, the video transmission terminal (STA) 201 wirelessly transmits a second video for the video display terminal (AP) 202 to the video display terminal (AP) 202. The video display terminal (AP) 202 wirelessly receives the second video to cause the display unit 11 to display the second video and wirelessly transmits the second video to the video display terminal (STA) 203 (corresponding to steps S104 and S121). Thereafter, the video transmission terminal (STA) 201 and the video display terminal (AP) 202 perform a process similar to a process performed on the second video for a third video.

In this embodiment, the transmission destination of the video is only a video display terminal wirelessly transmitting the connection request to the video display terminal. Thus, it is possible to omit ineffective wireless transmission of a video as compared to the first embodiment. As a result, as compared to the first embodiment, it is possible to further reduce the degradation of throughput at the time of video transmission from the video transmission terminal to each video display terminal.

### Fifth Embodiment

Next, the fifth embodiment of the present invention will be described. The configuration of the video display terminal according to this embodiment is the same as that illustrated in FIG. 1. In this embodiment, when the wireless communication unit 10 has wirelessly received limitation information representing that a display of a video is limited along with the video for its own terminal from the video transmission terminal, the control unit 13 causes the wireless communication unit 10 to wirelessly transmit the video for the own terminal obtained by performing image processing (video processing) for degrading visibility of the video to another video display terminal.

The configuration of the video transmission terminal according to this embodiment is the same as that illustrated in FIG. 4. In this embodiment, the control unit 22 causes the wireless communication unit 20 to wirelessly transmit limitation information representing that a display of a video is limited to a first video display terminal along with the video for the first video display terminal which operates as an AP. The limitation of the display of the video in this embodiment represents the degradation of visibility of image quality.

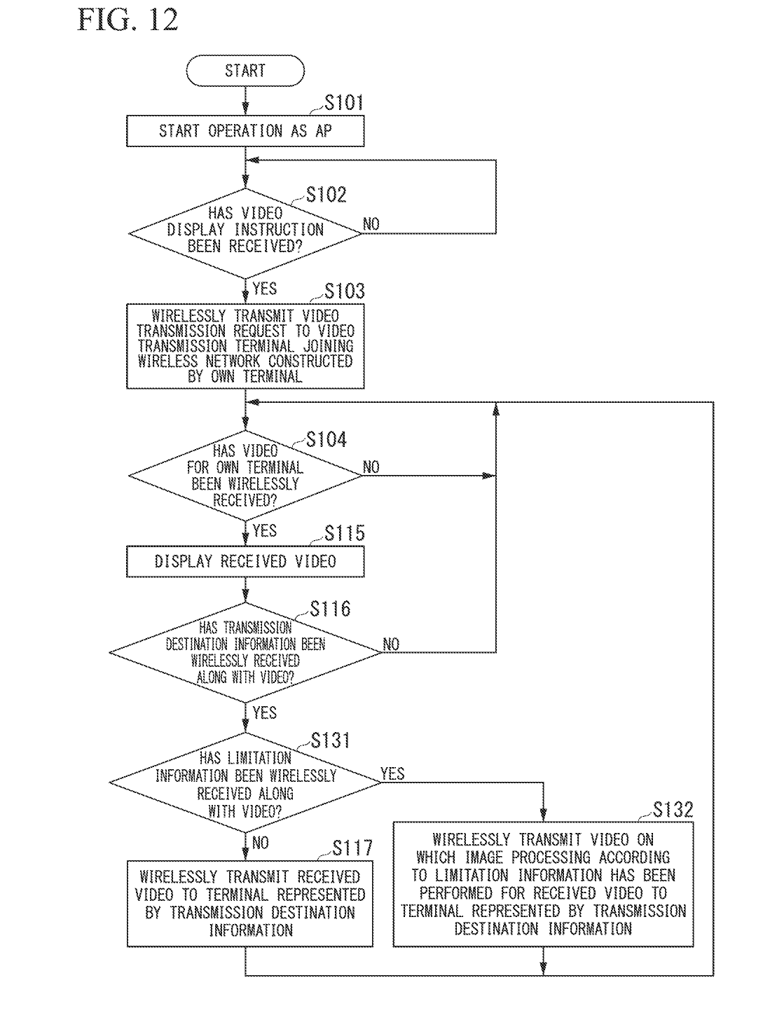

FIG. 12 illustrates the operation of the video display terminal. Hereinafter, parts of the operation of the video display terminal different from the operation illustrated in FIG. 5 will be described.

When the transmission destination information has been wirelessly received along with the video in step S116, the control unit 13 determines whether the limitation information has been wirelessly received along with the video (step S131). When the limitation information has not been wirelessly received along with the video for the own terminal in step S104, the process of step S104 is performed. When the limitation information has been wirelessly transmitted along with the video for the own terminal from the video transmission terminal in response to a video transmission request, the wireless communication unit 10 wirelessly receives the limitation information along with the video for the own terminal. At this time, the control unit 13 causes the wireless communication unit 10 to wirelessly receive the limitation information along with the video for the own terminal wirelessly transmitted from the video transmission terminal in response to the video transmission request.

When the limitation information has been wirelessly received along with the video, the wireless communication unit 10 wirelessly transmits a video obtained by performing image processing on the video for the own terminal according to the limitation information to a video display terminal represented by transmission destination information (step S132). At this time, the control unit 13 performs the image processing for degrading video visibility on the received video for the own terminal according to the limitation information. Further, the control unit 13 causes the wireless communication unit 10 to wirelessly transmit the video for the own terminal after the image processing to the video display terminal represented by the transmission destination information. After the video has been wirelessly transmitted, the process of step S104 is performed. When the limitation information has not been wirelessly transmitted along with the video, the process of step S104 is performed after the video has been wirelessly transmitted to the video display terminal represented by the transmission destination information in step S117.

The image processing to be performed on the video in this embodiment is a process of degrading image quality or a process of adding information representing a limitation of a display to the video. The process of degrading the image quality is a process of degrading image resolution, a process of masking part of the video, or the like. The process of adding the information representing the limitation of the display to the video is a process of inserting a watermark into the video or the like.

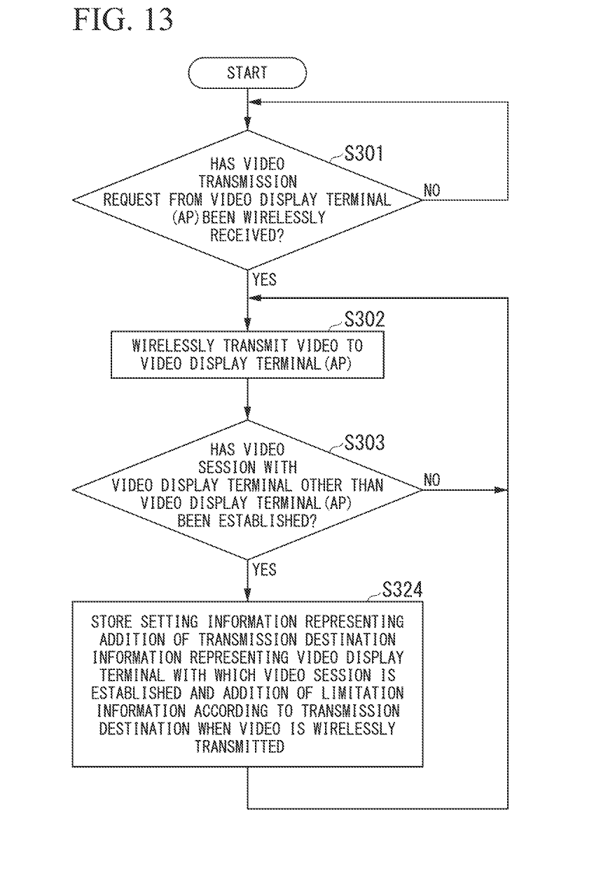

FIG. 13 illustrates the operation of the video transmission terminal. Hereinafter, parts of the operation of the video transmission terminal different from the operation illustrated in FIG. 6 will be described.

When the video session with the video display terminal other than the video display terminal (AP) is established in step S303, the control unit 22 causes the storage unit 21 to store setting information representing addition of transmission destination information representing the video display terminal with which the video session has been established and addition of limitation information according to a transmission destination when a video is wirelessly transmitted in a subsequent process (step S324). A process of storing the setting information in step S324 is not an essential process for obtaining an effect of reducing the degradation of throughput at the time of video transmission from the video transmission terminal without causing a disconnection of the network.

After the setting information has been stored in the storage unit 21, the process of step S302 is performed. When the process of step S324 has been performed, the wireless communication unit 20 wirelessly transmits the transmission destination information and the limitation information according to the transmission destination to the video display terminal (AP) along with the video stored in the storage unit 21 in step S302. In addition, in step S302, the control unit 22 causes the wireless communication unit 20 to wirelessly transmit the transmission destination information and the limitation information according to the transmission destination to the video display terminal (AP) along with the video stored in the storage unit 21 according to the setting information stored in the storage unit 21.

In this embodiment, limitation information of content corresponding to each transmission destination is wirelessly transmitted. For example, the limitation information representing that the video resolution is converted into 640×480 is wirelessly transmitted to a first transmission destination, and the limitation information representing that the video resolution is converted into 120×90 is wirelessly transmitted to a second transmission destination. When establishing the video session, the video transmission terminal acquires information of the resolution compatible with the video display terminal. The video transmission terminal causes the storage unit 21 to store the information of the resolution acquired from each video display terminal as limitation information capable of being set.

An example in which the operation of the video transmission terminal is an operation obtained by changing the operation illustrated in FIG. 6 has been described above. The operation of the video transmission terminal may be obtained by changing the operation illustrated in FIG. 8. That is, in the operation illustrated in FIG. 8, the process of step S315 may be replaced with the process of step S324.

Although the limitation information of content corresponding to each transmission destination is wirelessly transmitted in the above description, the limitation information of the same content may be wirelessly transmitted regardless of the transmission destination. For example, limitation information representing that a process of inserting a watermark into a video is performed may be wirelessly transmitted to any transmission destination.

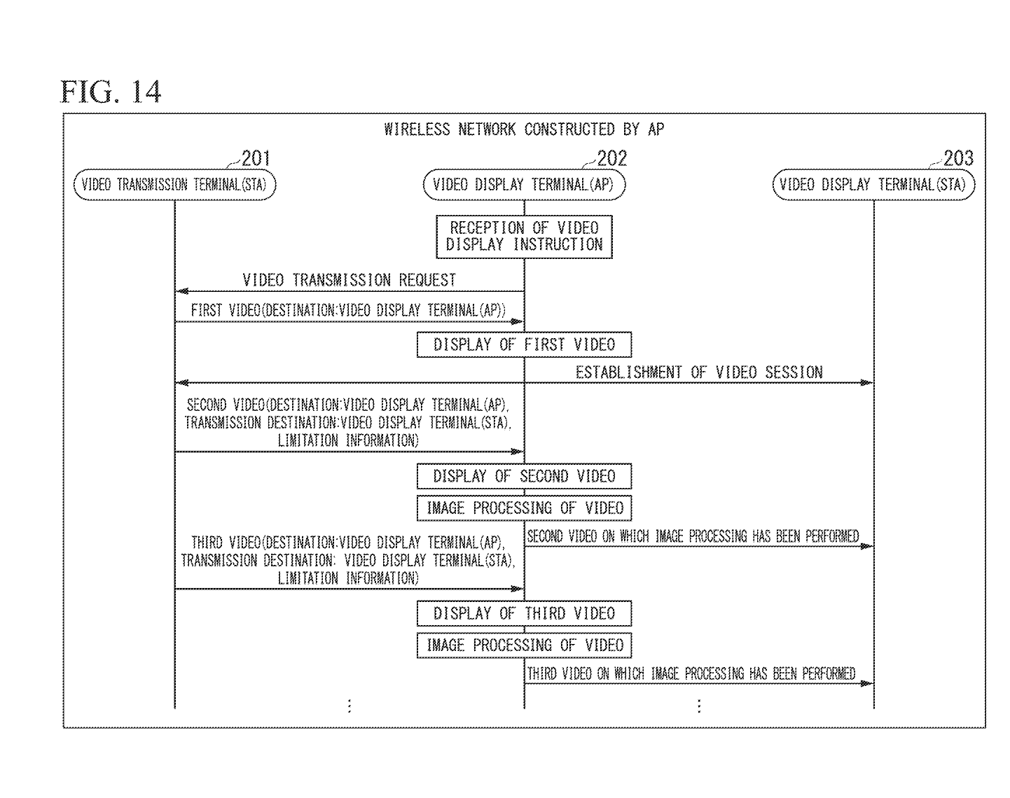

FIG. 14 illustrates operations of a video transmission terminal (STA) 201, a video display terminal (AP) 202, and a video display terminal (STA) 203 in the wireless network. Each terminal joins the wireless network constructed by the video display terminal (AP) 202. The video session is established between the video transmission terminal (STA) 201 and the video display terminal (AP) 202.

When the video display terminal (AP) 202 receives the video display instruction (corresponding to step S102), the video display terminal (AP) 202 wirelessly transmits the video transmission request to the video transmission terminal (STA) 201 (corresponding to step S103). The video transmission terminal (STA) 201 wirelessly receives the video transmission request (corresponding to step S301), and the video transmission terminal (STA) 201 wirelessly transmits a first video for the video display terminal (AP) 202 to the video display terminal (AP) 202 (corresponding to step S302). The video display terminal (AP) 202 wirelessly receives the first video and causes the display unit 11 to display the first video (corresponding to steps S104 and S115).

Thereafter, the video session is established between the video transmission terminal (STA) 201 and the video display terminal (STA) 203. After the video session has been established, the video transmission terminal (STA) 201 wirelessly transmits a second video for the video display terminal (AP) 202, transmission destination information representing that a transmission destination is the video display terminal (STA) 203, and limitation information to the video display terminal (AP) 202 (corresponding to steps S324 and S302). The video display terminal (AP) 202 receives the second video, the transmission destination information, and the limitation information and causes the display unit 11 to display the second video (corresponding to steps S104 and S115). Further, after imaging processing on the second video according to the limitation information, the video display terminal (AP) 202 wirelessly transmits the second video after the image processing to the video display terminal (STA) 203 according to the transmission destination information (corresponding to step S132). Thereafter, the video transmission terminal (STA) 201 and the video display terminal (AP) 202 perform a process similar to a process performed on the second video for a third video.

In this embodiment, it is possible to reduce the degradation of throughput at the time of video transmission from the video transmission terminal to each video display terminal while implementing the limitation of a video by degrading video visibility on the video whose transmission is limited due to copyright or the like.

### Sixth Embodiment

Next, the sixth embodiment of the present invention will be described. A configuration of a video display terminal according to this embodiment is the same as that illustrated in FIG. 1. In this embodiment, when the wireless communication unit 10 has wirelessly received an encrypted video for its own terminal and encryption information according to a transmission destination represented by transmission destination information from a video transmission terminal, the control unit 13 decrypts the encrypted video for the own terminal, encrypts the decrypted video for the own terminal based on the encryption information, and causes the wireless communication unit 10 to wirelessly transmit the video for the own terminal encrypted based on the encryption information to another video display terminal.

A configuration of the video transmission terminal according to this embodiment is the same as that illustrated in FIG. 4. In this embodiment, the control unit 22 causes the wireless communication unit 10 to wirelessly transmit the encryption information according to the transmission destination represented by the transmission destination information to a first video display terminal along with the video for the first video display terminal which operates as an AP.

In this embodiment, for example, a pair of encryption keys are used in the video transmission terminal and each video display terminal. The encryption key differs according to each video display terminal. For example, an encryption key for encrypting the video for the video display terminal (AP), an encryption key for encrypting the video to be wirelessly transmitted to a second video display terminal other than the video display terminal (AP), and an encryption key for encrypting the video to be wirelessly transmitted to a third video display terminal other than the video display terminal (AP) and the second video display terminal are different from one another. These encryption keys, for example, are generated inside the video transmission terminal in advance. Alternatively, these encryption keys are generated in a process in which the video transmission terminal and each video display terminal transmit and receive information. The encryption key may be a group common key which is the same for each display terminal. The storage unit 21 of the video transmission terminal stores encryption information including an encryption key corresponding to each video display terminal.

Decryption is performed using the encryption key. In addition, the decryption may be performed using a decryption key different from the encryption key. When the decryption key different from the encryption key is used, the decryption key corresponding to the encryption key is generated like the encryption key. The decryption key is wirelessly transmitted from the video transmission terminal to each video display terminal in advance, and stored by each video display terminal.

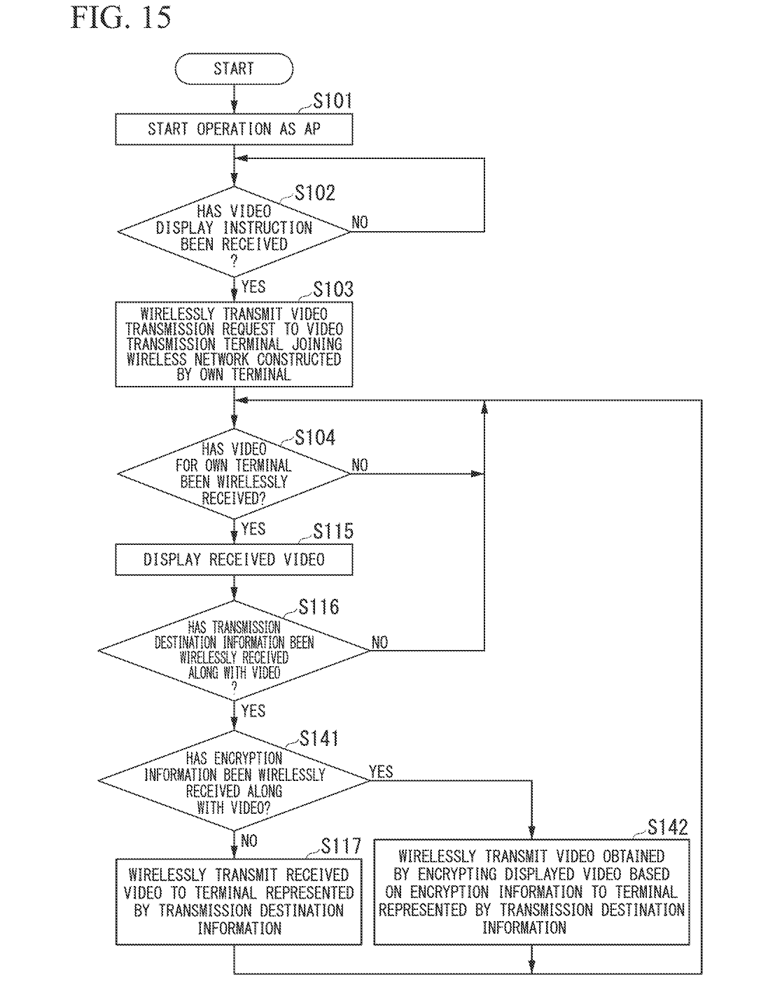

FIG. 15 illustrates the operation of the video display terminal. Hereinafter, parts of the operation of the video display terminal different from the operation illustrated in FIG. 5 will be described.

When transmission destination information has been wirelessly received along with a video in step S116, the control unit 13 determines whether encryption information has been wirelessly received along with the video (step S141). When the encryption information has not been wirelessly received along with the video for the own terminal in step S104, the process of step S104 is performed. When the encryption information has been wirelessly transmitted along with the video for the own terminal from the video transmission terminal in response to the video transmission request, the wireless communication unit 10 wirelessly receives the encryption information along with the video for the own terminal. At this time, the control unit 13 causes the wireless communication unit 10 to wirelessly receive the encryption information along with the video for the own terminal wirelessly transmitted from the video transmission terminal in response to the video transmission request. In this embodiment, the video for the own terminal encrypted by the video transmission terminal is wirelessly received.

When the encryption information has been wirelessly received along with the video, the wireless communication unit 10 wirelessly transmits a video obtained by encrypting the decrypted video for the own terminal based on the encryption information to the video display terminal represented by the transmission destination information (step S142). At this time, the control unit 13 encrypts the decrypted video for the own terminal based on the encryption information. Further, the control unit 13 causes the wireless communication unit 10 to wirelessly transmit the video for the own terminal encrypted based on the encryption information to the video display terminal represented by the transmission destination information. After the video has been wirelessly transmitted, the process of step S104 is performed. When the encryption information has not been wirelessly transmitted along with the video, the process of step S104 is performed after the video has been wirelessly transmitted to the video display terminal represented by the transmission destination information in step S117.

After the video has been wirelessly received in step S104 and before the video is displayed in step S115, the control unit 13 decrypts the received encrypted video for the own terminal. That is, the control unit 13 decrypts the encrypted video for the own terminal wirelessly transmitted from the video transmission terminal in response to the video transmission request and wirelessly received by the wireless communication unit 10 and causes the display unit 11 to display the decrypted video.

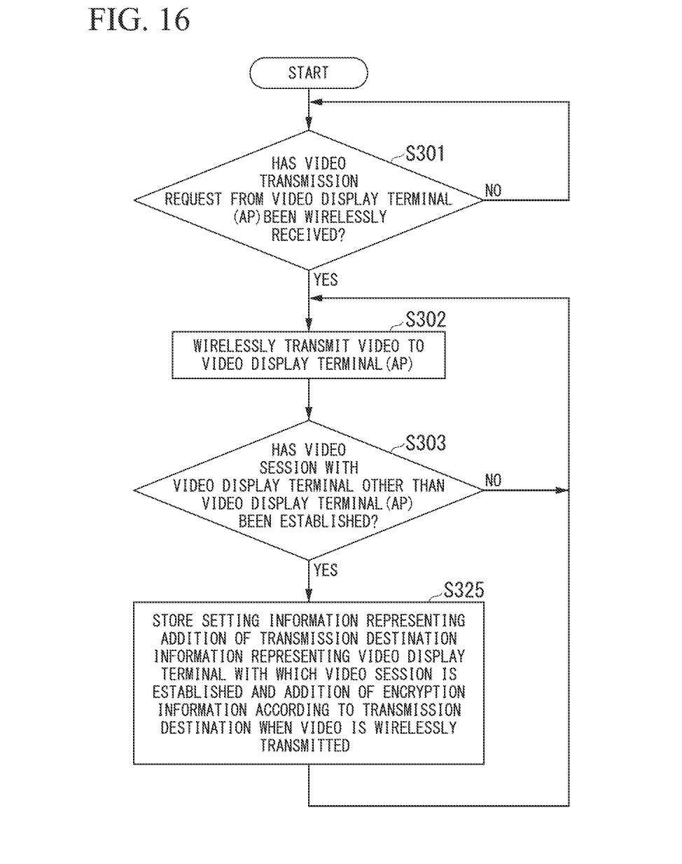

FIG. 16 illustrates an operation of the video transmission terminal. Hereinafter, parts of the operation of the video transmission terminal different from the operation illustrated in FIG. 6 will be described.

When the video session with the video display terminal other than the video display terminal (AP) is established in step S303, the control unit 22 causes the storage unit 21 to store setting information representing addition of transmission destination information representing the video display terminal with which the video session has been established and addition of encryption information according to a transmission destination when a video is wirelessly transmitted in a subsequent process (step S325). A process of storing the setting information in step S325 is not an essential process for obtaining an effect of reducing the degradation of throughput at the time of video transmission from the video transmission terminal without causing a disconnection of the network.

After the setting information has been stored in the storage unit 21, the process of step S302 is performed. When the process of step S325 has been performed, the wireless communication unit 20 wirelessly transmits the transmission destination information and the encryption information according to the transmission destination to the video display terminal (AP) along with the video stored in the storage unit 21 in step S302. In addition, in step S302, the control unit 22 causes the wireless communication unit 20 to wirelessly transmit the transmission destination information and the encryption information according to the transmission destination to the video display terminal (AP) along with the video stored in the storage unit 21 according to the setting information stored in the storage unit 21.

In the above description, the operation of the video transmission terminal obtained by changing the operation illustrated in FIG. 6 is presented. The operation of the video transmission terminal may be obtained by changing the operation illustrated in FIG. 8. That is, in the operation illustrated in FIG. 8, the process of step S315 may be replaced with the process of step S325.

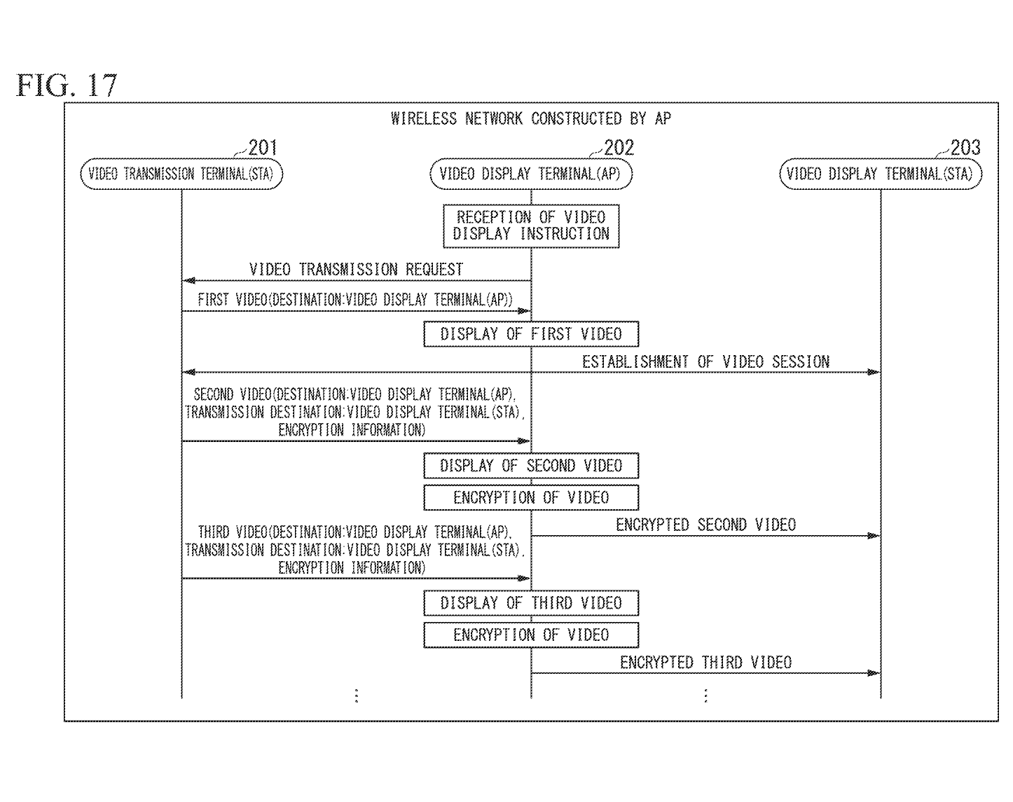

FIG. 17 illustrates operations of a video transmission terminal (STA) 201, a video display terminal (AP) 202, and a video display terminal (STA) 203 in the wireless network. Each terminal joins the wireless network constructed by the video display terminal (AP) 202. The video session is established between the video transmission terminal (STA) 201 and the video display terminal (AP) 202.

When the video display terminal (AP) 202 receives the video display instruction (corresponding to step S102), the video display terminal (AP) 202 wirelessly transmits the video transmission request to the video transmission terminal (STA) 201 (corresponding to step S103). The video transmission terminal (STA) 201 wirelessly receives the video transmission request (corresponding to step S301), and the video transmission terminal (STA) 201 wirelessly transmits a first video for the video display terminal (AP) 202 to the video display terminal (AP) 202 (corresponding to step S302). The video display terminal (AP) 202 wirelessly receives the first video and causes the display unit 11 to display the first video (corresponding to steps S104 and S115).

Thereafter, the video session is established between the video transmission terminal (STA) 201 and the video display terminal (STA) 203. After the video session has been established, the video transmission terminal (STA) 201 wirelessly transmits a second video for the video display terminal (AP) 202, transmission destination information representing that a transmission destination is the video display terminal (STA) 203, and encryption information to the video display terminal (AP) 202 (corresponding to steps S325 and S302). The video display terminal (AP) 202 receives the second video, the transmission destination information, and the encryption information to cause the display unit 11 to display the second video (corresponding to steps S104 and S115). Further, after encrypting the second video according to the encryption information, the video display terminal (AP) 202 wirelessly transmits the encrypted second video to the video display terminal (STA) 203 according to the transmission destination information (corresponding to step S142). Thereafter, the video transmission terminal (STA) 201 and the video display terminal (AP) 202 perform a process similar to a process performed on the second video for a third video.

In this embodiment, it is possible to reduce the degradation of throughput at the time of video transmission from the video transmission terminal to each video display terminal while implementing wireless transmission of an encrypted video.

### Seventh Embodiment

Next, the seventh embodiment of the present invention will be described. A configuration of a video display terminal according to this embodiment is the same as that illustrated in FIG. 1.

A configuration of the video transmission terminal according to this embodiment is the same as that illustrated in FIG. 4. In this embodiment, the control unit 22 counts the number of established video sessions. When the number of established video sessions is less than a predetermined number, the control unit 22 permits the establishment of a video session with a second video display terminal other than a first video display terminal which operates as an AP. When the number of established video sessions is greater than or equal to the predetermined number, the control unit 22 rejects the establishment of the video session with the second video display terminal. When the video session with the first video display terminal has been established, the control unit 22 permits the establishment of the video session with the second video display terminal regardless of the number of established video sessions.

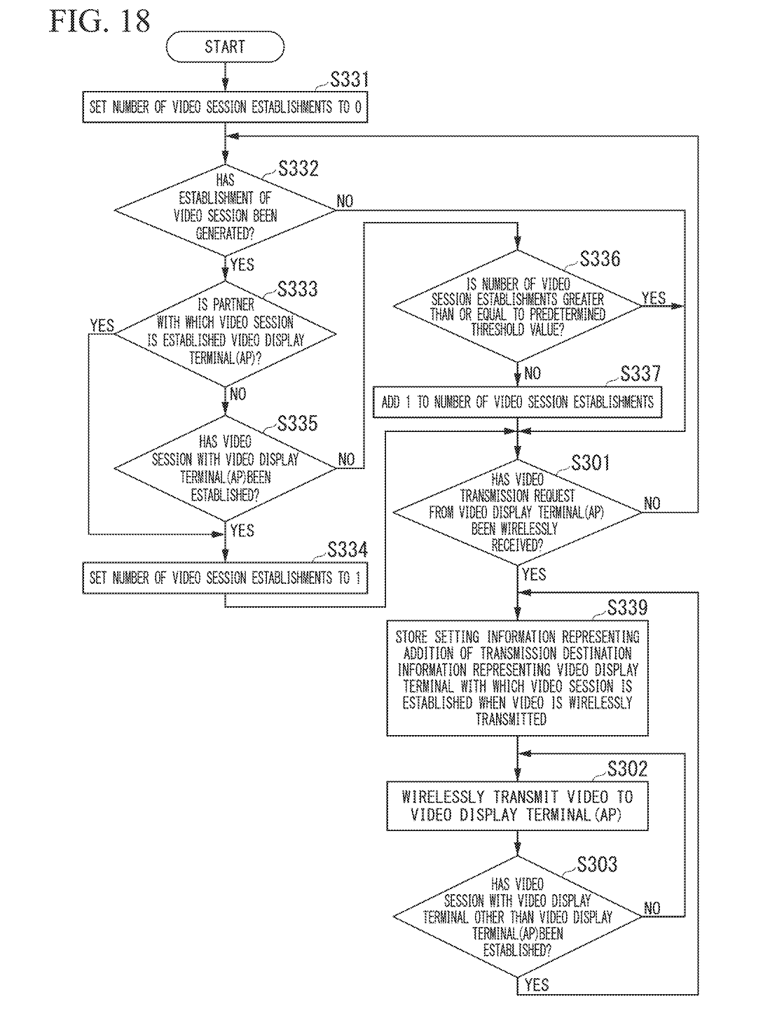

The operation of the video display terminal is the same as that illustrated in FIG. 5. FIG. 18 illustrates the operation of the video transmission terminal. Hereinafter, parts of the operation of the video transmission terminal different from the operation illustrated in FIG. 6 will be described.

The control unit 22 sets the number of video session establishments representing the number of established video sessions to 0 (step S331). The number of established video sessions is equal to the number of partner video display terminals with which the video transmission terminal has established the video session. After the number of video session establishments has been set to 0, the control unit 22 determines whether the establishment of the video session has occurred (step S332). If the process of establishing the video session is started and is in execution, it is determined that the establishment of the video session has occurred. If the process of establishing the video session is not in execution, it is determined that the establishment of the video session has not occurred

When the establishment of the video session has not occurred, the process of step S301 is performed. When the establishment of the video session has occurred, the control unit 22 determines whether a partner with which the video session is established is the video display terminal (AP) (step S333). Although not illustrated, the video transmission terminal transmits a connection request to the video display terminal (AP) when joining the wireless network constructed by the video display terminal (AP), and receives a connection request response from the video display terminal (AP). Thereby, the video transmission terminal can obtain information of a terminal which is the AP. On the other hand, the video transmission terminal can obtain information of whether the partner with which the video session is established is the video display terminal according to information acquired during the establishment of the video session or the connection request and the connection request response. The video transmission terminal can determine whether the partner with which the video session is established is the video display terminal (AP) according to information of the terminal which is the AP and information of whether the partner with which the video session is established is the video display terminal. When the partner with which the video session is established is the video display terminal (AP), the control unit 22 sets the number of video session establishments to 1 (step S334). In this case, in the process of establishing the video session (not illustrated), the establishment of the video session succeeds. After the number of video session establishments has been set to 1, the process of step S301 is performed.

When the partner with which the video session is established is not the video display terminal (AP), the control unit 22 determines whether the video session with the video display terminal (AP) is established (step S335). When the video session with the video display terminal (AP) is established, the process of step S334 is performed. In this case, in the process of establishing the video session (not illustrated), the establishment of the video session succeeds.

When the video session with the video display terminal (AP) is not established, the control unit 22 determines whether the number of video session establishments is greater than or equal to a predetermined threshold value (step S336). When the number of video session establishments is greater than or equal to the predetermined threshold value, the process of step S301 is performed. In this case, in the process of establishing the video session (not illustrated), the establishment of the video session fails. When the establishment of the video session has failed, for example, a response representing the failure of the establishment of the video session is transmitted to a partner terminal. Alternatively, the response to the partner terminal is not transmitted.

When the number of video session establishments is less than the predetermined threshold value, the control unit 22 adds 1 to the number of video session establishments (step S337). In this case, in the process of establishing the video session (not illustrated), the establishment of the video session succeeds. After 1 is added to the number of video session establishments, the process of step S301 is performed.

When the video transmission request is not wirelessly received from the video display terminal (AP) in step S301, the process of step S332 is performed. When the video transmission request has been wirelessly received from the video display terminal (AP) in step S301, the control unit 22 causes the storage unit 21 to store setting information representing addition of transmission destination information representing the video display terminal with which the video session has been established when a video is wirelessly transmitted in a subsequent process (step S339). A process of storing the setting information in step S339 is not an essential process for obtaining an effect of reducing the degradation of throughput at the time of video transmission from the video transmission terminal without causing a disconnection of the network.

After the setting information has been stored in the storage unit 21, the video is wirelessly transmitted in step S302. After the video has been wirelessly transmitted, the process of step S303 is performed. When the video session with the video display terminal other than the video display terminal (AP) is established in step S303, the process of step S339 is performed.

In the above-described process, the establishment of the video session is permitted until the number of video session establishments reaches the predetermined threshold value when the establishment of the video session between the video transmission terminal and the video display terminal (AP) does not occur. When the number of video session establishments reaches the predetermined threshold value, the establishment of the video session between the video transmission terminal and a terminal other than the video display terminal (AP) is rejected. However, when the establishment of the video session has occurred between the video transmission terminal and the video display terminal (AP) or when the video session is established between the video transmission terminal and the video display terminal (AP), the establishment of the video session is permitted regardless of the number of video session establishments.

That is, the control unit 22 counts the number of established video sessions (step S337). When the number of established video sessions is less than the predetermined number (step S336), the control unit 22 permits the establishment of the video session with the video display terminal other than the video display terminal (AP). When the number of established video sessions is greater than or equal to the predetermined number (step S336), the control unit 22 rejects the establishment of the video session with the video display terminal other than the video display terminal (AP). When the video session with the video display terminal (AP) has been established (step S335), the control unit 22 permits the establishment of the video session with the video display terminal other than the video display terminal (AP) regardless of the number of established video sessions.

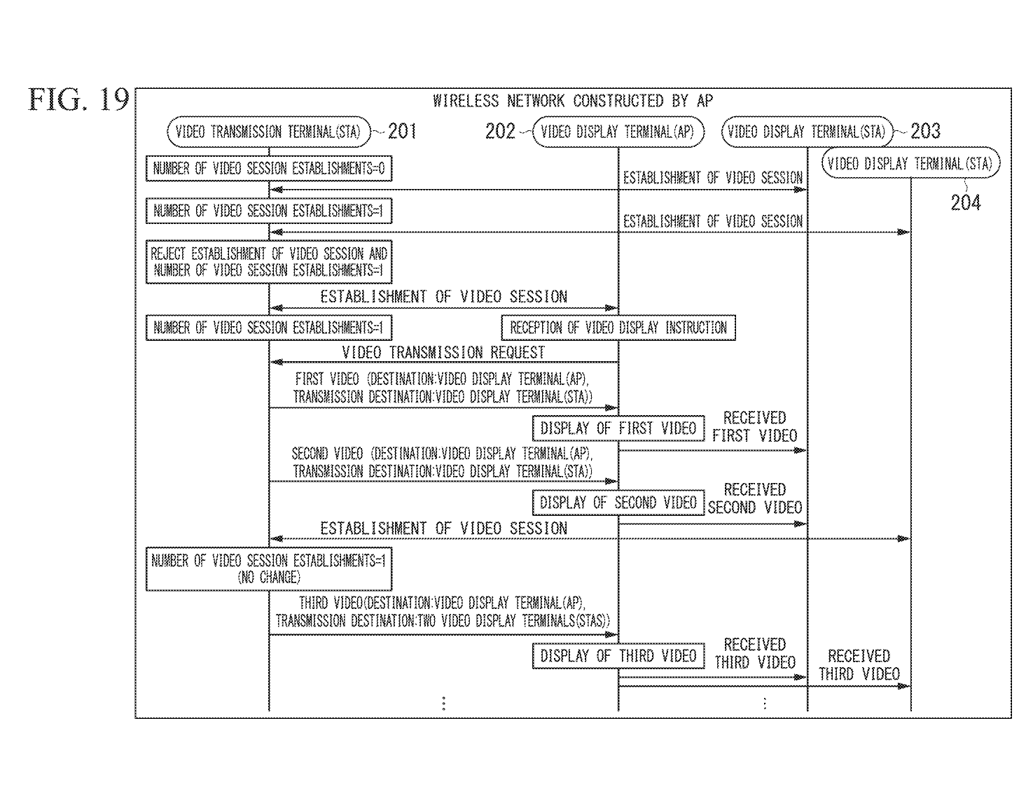

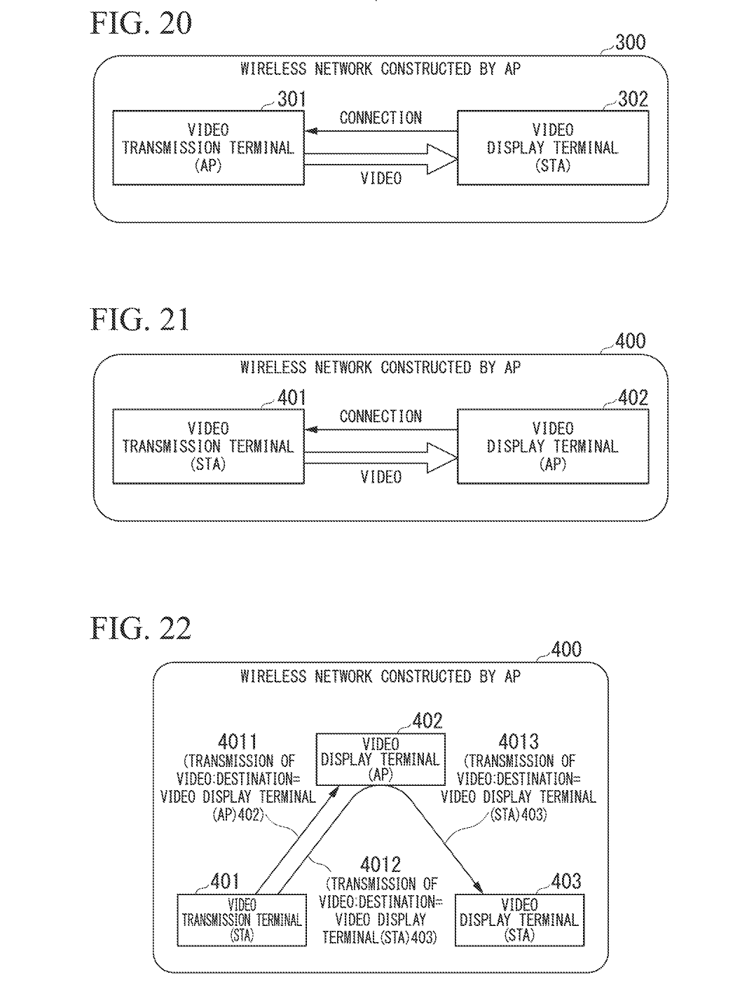

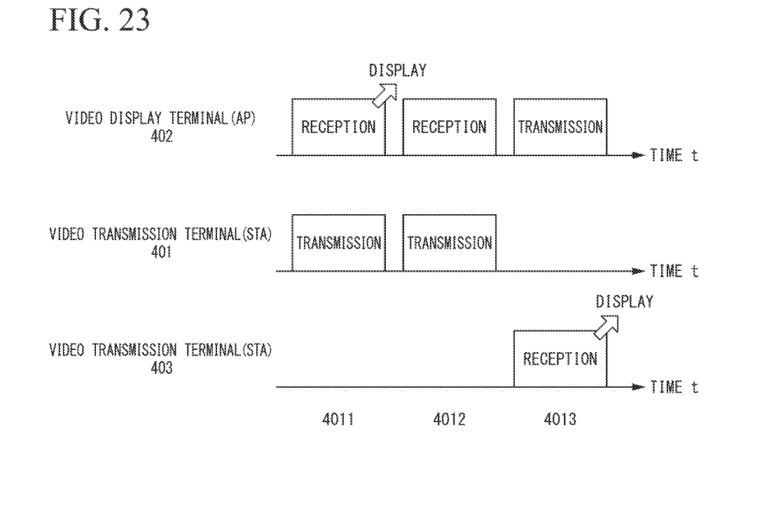

FIG. 19 illustrates operations of a video transmission terminal (STA) 201, a video display terminal (AP) 202, and video display terminals (STA) 203 and 204 in the wireless network. Each terminal joins the wireless network constructed by the video display terminal (AP) 202. In this example, the threshold value of the number of video session establishments is 1.

The number of video session establishments counted by the video transmission terminal (STA) 201 is initially 0. When the establishment of the video session between the video transmission terminal (STA) 201 and the video display terminal (STA) 203 occurs, the number of video session establishments is set to 1 (corresponding to step S337). Subsequently, when the establishment of the video session occurs between the video transmission terminal (STA) 201 and the video display terminal (STA) 204, the establishment of the video session is rejected because the number of video session establishments reaches the threshold value (=1) (corresponding to step S336). Subsequently, the establishment of the video session between the video transmission terminal (STA) 201 and the video display terminal (AP) 202 occurs (corresponding to steps S332 and S333). In this case, the number of video session establishments is set to 1 (corresponding to step S334).

Thereafter, when the video display terminal (AP) 202 receives the video display instruction (corresponding to step S102), the video display terminal (AP) 202 wirelessly transmits the video transmission request to the video transmission terminal (STA) 201 (corresponding to step S103). The video transmission terminal (STA) 201 wirelessly receives the video transmission request (corresponding to step S301), and wirelessly transmits a first video for the video display terminal (AP) 202 and transmission destination information representing that a transmission destination is the video display terminal (STA) 203 to the video display terminal (AP) 202 (corresponding to steps S339 and S302). The video display terminal (AP) 202 receives the first video and the transmission destination information and causes the display unit 11 to display the first video (corresponding to steps S104 and S115), and wirelessly transmits the first video to the video display terminal (STA) 203 according to the transmission destination information (corresponding to step S117). Thereafter, the video transmission terminal (STA) 201 and the video display terminal (AP) 202 perform a process similar to a process performed on the first video for a second video.

Thereafter, the establishment of the video session occurs between the video transmission terminal (STA) 201 and the video display terminal (STA) 204. Because the video session is already established between the video transmission terminal (STA) 201 and the video display terminal (AP) 202, the number of video session establishments is continuously 1 (corresponding to step S334) and the establishment of the video session is permitted. After the video session has been established, the video transmission terminal (STA) 201 wirelessly transmits a third video for the video display terminal (AP) 202 and the transmission destination information representing that the transmission destination is the video display terminals (STAs) 203 and 204 to the video display terminal (AP) 202 (corresponding to steps S339 and S302). The video display terminal (AP) 202 receives the third video and the transmission destination information and causes the display unit 11 to display the third video (corresponding to steps S104 and S115), and wirelessly transmits the third video to the video display terminals (STAs) 203 and 204 according to the transmission destination information (corresponding to step S117).

In this embodiment, even when there is an upper limit to the number of video sessions with which the video transmission terminal (STA) can be established due to a limitation of a use memory amount or the like of the video transmission terminal (STA), it is possible to transmit a video to a number of video display terminals (a video display terminal (AP) and a video transmission terminal (STA)) exceeding the upper limit. In addition, it is possible to reduce the degradation of throughput at the time of video transmission from the video transmission terminal to each video display terminal while transmitting such a video.

While the embodiments of the present invention have been described in detail above with reference to the drawings, specific configurations are not limited to the above-described embodiments and the present invention is not limited to the embodiments. Additions, omissions, substitutions, and other modifications can be made without departing from the spirit and scope of the present invention. Accordingly, the invention is not to be considered as being limited by the foregoing description, and is only limited by the scope of the appended claims.

What is claimed is:

1. A video display terminal comprising:
a wireless communication interface configured to wirelessly communicate with another terminal;
a display interface configured to display a video;
an operation interface configured to receive an operation of a user; and
a control unit configured to cause the wireless communication interface to wirelessly transmit a video transmission request to a video transmission terminal joining a wireless network constructed by the own video display terminal if the operation interface receives a video display instruction when the own video display terminal operates as an access point (AP) constructing the wireless network, cause the display interface to display a video for the own video display terminal wirelessly transmitted from the video transmission terminal in response to the video transmission request and wirelessly received by the wireless communication interface, and cause the wireless communication interface to wirelessly transmit the video for the own video display terminal to another video display terminal joining the wireless network constructed by the own video display terminal.

2. The video display terminal according to claim 1, wherein, when the wireless communication interface has received transmission destination information representing a transmission destination of the video for the own video display terminal, along with the video for the own video display terminal, from the video transmission terminal, the control unit causes the wireless communication interface to wirelessly transmit the video for the own video display terminal to a video display terminal represented by the transmission destination information.

3. The video display terminal according to claim 1, wherein, when the wireless communication interface has wirelessly received terminal information representing whether a wireless terminal is a video display terminal from the wireless terminal which has not joined the wireless network constructed by the own video display terminal and is other than the video transmission terminal, the control unit causes the wireless communication interface to wirelessly transmit the video for the own video display terminal to only the wireless terminal wirelessly transmitting terminal information representing that the wireless terminal is the video display terminal after the wireless terminal has joined the wireless network constructed by the own video display terminal.

4. The video display terminal according to claim 1, wherein, when the wireless communication interface has wirelessly received limitation information representing that a display of a video is limited, along with the video for the own video display terminal, from the video transmission terminal, the control unit causes the wireless communication interface to wirelessly transmit the video for the own video display terminal obtained by performing image processing for degrading visibility of a video to the other video display terminal.

5. The video display terminal according to claim 2, wherein, when the wireless communication interface has wirelessly received encryption information in accordance with the transmission destination represented by the transmission destination information, along with the encrypted video for the own video display terminal, from the video transmission terminal, the control unit decrypts the encrypted video for the own video display terminal, encrypts the decrypted video for the own video display terminal based on the encryption information, and causes the wireless communication interface to wirelessly transmit the video for the own video display terminal encrypted based on the encryption information to the other video display terminal.

6. A video transmission terminal comprising:
a wireless communication interface configured to wirelessly communicate with another terminal; and
a control unit configured to cause the wireless communication interface to wirelessly transmit a video to a first video display terminal when the wireless communication interface has wirelessly received a video transmission request from the first video display terminal which operates as an AP constructing a wireless network that the own video transmission terminal has joined and cause the wireless communication interface to wirelessly transmit transmission destination information representing that a transmission destination of the video for the first video display terminal is a second video display terminal to the first video display terminal along with the video for the first video display terminal if a video session with the second video display terminal other than the first video display terminal is established when a video session with the first video display terminal is established.

7. The video transmission terminal according to claim 6, wherein, when the wireless communication interface has wirelessly received a video transmission request from the second video display terminal with which the video session has been established, the control unit causes the wireless communication interface to wirelessly transmit the transmission destination information to the first video display terminal along with the video for the first video display terminal.

8. The video transmission terminal according to claim 6, wherein the control unit causes the wireless communication interface to wirelessly transmit limitation information representing that a display of a video is limited to the first video display terminal along with the video for the first video display terminal.

9. The video transmission terminal according to claim 6, wherein the control unit causes the wireless communication interface to wirelessly transmit encryption information in accordance with the transmission destination represented by the transmission destination information to the first video display terminal along with the video for the first video display terminal.

10. The video transmission terminal according to claim 6,
wherein the control unit permits establishment of a video session with the second video display terminal when a number of established video sessions is counted and the number of established video sessions is less than a predetermined number,
wherein the control unit rejects the establishment of the video session with the second video display terminal when the number of established video sessions is greater than or equal to the predetermined number, and
wherein the control unit permits the establishment of the video session with the second video display terminal regardless of the number of established video sessions when a video session with the first video display terminal has been established.

11. A video communication system comprising:
a first video display terminal; and
a video transmission terminal joining a wireless network constructed by the first video display terminal,
wherein the first video display terminal includes:
a first wireless communication interface configured to wirelessly communicate with another terminal;
a display interface configured to display a video;
an operation interface configured to receive an operation of a user; and
a first control unit configured to cause the first wireless communication interface to wirelessly transmit a video transmission request to the video transmission terminal if the operation interface receives a video display instruction when the first video display terminal operates as an AP constructing the wireless network, cause the display interface to display a video for the first video display terminal wirelessly transmitted from the video transmission terminal in response to the video transmission request and wirelessly received by the first wireless communication interface, and cause the first wireless communication interface to wirelessly transmit the video for the first video display terminal to a second video display terminal which joins the wireless network constructed by the first video display terminal and is other than the first video display terminal, and
wherein the video transmission terminal includes:
a second wireless communication interface configured to wirelessly communicate with another terminal; and
a second control unit configured to cause the second wireless communication interface to wirelessly transmit a video to the first video display terminal when the second wireless communication interface has wirelessly received the video transmission request from the first video display terminal and cause the second wireless communication interface to wirelessly transmit transmission destination information representing that a transmission destination of the video for the first video display terminal is a second video display terminal to the first video display terminal along with the video for the first video display terminal if a video session with the second video display terminal is established when a video session with the first video display terminal is established.

12. A video display method comprising the steps of:
wirelessly transmitting, by a wireless communication interface provided in a first video display terminal, a video transmission request to a video transmission terminal joining a wireless network constructed by the first video display terminal if an operation interface provided in the first video display terminal receives a video display instruction when the first video display terminal operates as an AP constructing the wireless network; and
displaying, by a display interface, a video for the first video display terminal wirelessly transmitted from the video transmission terminal in response to the video transmission request and wirelessly received by the wireless communication interface, and wirelessly transmitting, by the wireless communication interface, the video for the first video display terminal to a second video display terminal which joins the wireless network constructed by the first video display terminal and is other than the first video display terminal.

13. A video transmission method comprising the steps of:
wirelessly transmitting, by a wireless communication interface provided in a video transmission terminal, a video to a first video display terminal when the wireless communication interface has wirelessly received a video transmission request from the first video display terminal which operates as an AP constructing a wireless network that the video transmission terminal has joined; and
wirelessly transmitting, by the wireless communication interface, transmission destination information representing that a transmission destination of the video for the first video display terminal is a second video display terminal to the first video display terminal along with the video for the first video display terminal if a video session with a second video display terminal other than the first video display terminal is established when a video session with the first video display terminal is established.

14. A computer-readable recording medium recording a program for causing a computer to execute the steps of:
causing a wireless communication interface provided in a first video display terminal to wirelessly transmit a video transmission request to a video transmission terminal joining a wireless network constructed by the first video display terminal if an operation interface provided in the first video display terminal receives a video display instruction when the first video display terminal operates as an AP constructing the wireless network; and
causing a display interface to display a video for the first video display terminal wirelessly transmitted from the video transmission terminal in response to the video transmission request and wirelessly received by the wireless communication interface and causing the wireless communication interface to wirelessly transmit the video for the first video display terminal to a second video display terminal which joins the wireless network constructed by the first video display terminal and is other than the first video display terminal.

15. A computer-readable recording medium recording a program for causing a computer to execute the steps of:
causing a wireless communication interface provided in a video transmission terminal to wirelessly transmit a video to a first video display terminal when the wireless communication interface has wirelessly received a video transmission request from the first video display terminal which operates as an AP constructing a wireless network that the video transmission terminal has joined; and
causing the wireless communication interface to wirelessly transmit transmission destination information representing that a transmission destination of the video for the first video display terminal is a second video display terminal to the first video display terminal along with the video for the first video display terminal if a video session with a second video display terminal other than the first video display terminal is established when a video session with the first video display terminal is established.
